SEQUENCE LISTING (18 sequences)

SEQ ID NO: 1 - DNA, 59 bp, Artificial Sequence
  Synthetic oligonucleotide
aaaaaaagcggccgcggagcatcatcaccatcaccaccaccaccaccactgagatccgg

SEQ ID NO: 2 - DNA, 18 bp, Artificial Sequence
  Synthetic oligonucleotide
ccaatgcttaatcagtga

SEQ ID NO: 3 - DNA, 49 bp, Artificial Sequence
  Synthetic oligonucleotide
ctttctatgcggcccagccggccatggccgakgtsvagcttcaggagtc

SEQ ID NO: 4 - DNA, 34 bp, Artificial Sequence
  Synthetic oligonucleotide
aaaaaagcggccgcgctcgagacggtgaccgtgg

SEQ ID NO: 5 - DNA, 45 bp, Artificial Sequence
  Synthetic oligonucleotide
aaaaaaggcccagccggccatggcgtcgacggatattttgatgac

SEQ ID NO: 6 - DNA, 36 bp, Artificial Sequence
  Synthetic oligonucleotide
tttctcgtgcggccgcacgttttatttccaactttg

SEQ ID NO: 7 - DNA, 5217 bp, Artificial Sequence
  Synthetic polynucleotide
ctagaaataattttgtttaactttaagaaggagatatacatatgaaaataaaaacaggtgcacgcatcctcgcattatccgcattaacgacgatgatgttttccgcctcggctctcgccaaaatcgaagaaggtaaactggtaatctggattaacggcgataaaggctataacggtctcgctgaagtcggtaagaaattcgagaaagataccggaattaaagtcaccgttgagcatccggataaactggaagagaaattcccacaggttgcggcaactggcgatggccctgacattatcttctgggcacacgaccgctttggtggctacgctcaatctggcctgttggctgaaatcaccccggacaaagcgttccaggacaagctgtatccgtttacctgggatgccgtacgttacaacggcaagctgattgcttacccgatcgctgttgaagcgttatcgctgatttataacaaagatctgctgccgaacccgccaaaaacctgggaagagatcccggcgctggataaagaactgaaagcgaaaggtaagagcgcgctgatgttcaacctgcaagaaccgtacttcacctggccgctgattgctgctgacgggggttatgcgttcaagtatgaaaacggcaagtacgacattaaagacgtgggcgtggataacgctggcgcgaaagcgggtctgaccttcctggttgacctgattaaaaacaaacacatgaatgcagacaccgattactccatcgcagaagctgcctttaataaaggcgaaacagcgatgaccatcaacggcccgtgggcatggtccaacatcgacaccagcaaagtgaattatggtgtaacggtactgccgaccttcaagggtcaaccatccaaaccgttcgttggcgtgctgagcgcaggtattaacgccgccagtccgaacaaagagctggcaaaagagttcctcgaaaactatctgctgactgatgaaggtctggaagcggttaataaagacaaaccgctgggtgccgtagcgctgaagtcttacgaggaagagttggcgaaagatccacgtattgccgccaccatggaaaacgcccagaaaggtgaaatcatgccgaacatcccgcagatgtccgctttctggtatgccgtgcgtactgcggtgatcaacgccgccagcggtcgtcagactgtcgatgaagccctgaaagacgcgcagactaattcgagctcgaacaacaacaacaataacaataacaacaacctcgggccgggtgcggcacactacgtagaattcgcggcccagccggccatggccgactacaaagatattgtgctgacacagtctcctgcttccttagctgtatctctggggcagagggccaccatctcatgcagggccagccaaagtgtcagtacatctacctatagttatttacactggtaccaacagagaccaggacagccacccaaactcatcaagtatgtatccaacctagaatctggggtccctgccaggttcagtggcagtgggtctgggacagacttcaccctcaacatccatcctgtggaggaggaggatactgcaacatattactgtcagcacagttgggagattcctccgacgttcggtggaggcaccaagctggaaataaaacgtgcggccgcggtcgagcaccaccaccaccaccactgagatccggctgctaacaaagcccgaaaggaagctgagttggctgctgccaccgctgagcaataactagcataaccccttggggcctctaaacgggtcttgaggggttttttgctgaaaggaggaactatatccggattggcgaatgggacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgattagggtgatggttcacgtagtgggccatcgccctgatagacggtttttcgccctttgacgttggagtccacgttctttaatagtggactcttgttccaaactggaacaacactcaaccctatctcggtctattcttttgatttataagggattttgccgatttcggcctattggttaaaaaatgagctgatttaacaaaaatttaacgcgaattttaacaaaatattaacgtttacaatttcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcacgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgcagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgtccttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcacacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcctgatgcggtattttctccttacgcatctgtgcggtatttcacaccgcatatatggtgcactctcagtacaatctgctctgatgccgcatagttaagccagtatacactccgctatcgctacgtgactgggtcatggctgcgccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcgaggcagctgcggtaaagctcatcagcgtggtcgtgaagcgattcacagatgtctgcctgttcatccgcgtccagctcgttgagtttctccagaagcgttaatgtctggcttctgataaagcgggccatgttaagggcggttttttcctgtttggtcactgatgcctccgtgtaagggggatttctgttcatgggggtaatgataccgatgaaacgagagaggatgctcacgatacgggttactgatgatgaacatgcccggttactggaacgttgtgagggtaaacaactggcggtatggatgcggcgggaccagagaaaaatcactcagggtcaatgccagcgcttcgttaatacagatgtaggtgttccacagggtagccagcagcatcctgcgatgcagatccggaacataatggtgcagggcgctgacttccgcgtttccagactttacgaaacacggaaaccgaagaccattcatgttgttgctcaggtcgcagacgttttgcagcagcagtcgcttcacgttcgctcgcgtatcggtgattcattctgctaaccagtaaggcaaccccgccagcctagccgggtcctcaacgacaggagcacgatcatgcgcacccgtggccaggacccaacgctgcccgagatctcgatcccgcgaaattaatacgactcactatagggagaccacaacggtttccctctag

SEQ ID NO: 8 - DNA, 840 bp, Artificial Sequence
  Synthetic polynucleotide
caaattctatttcaaggagacagtcataatgaaatacctattgcctacggcagccgctggattgttattactcgcggcccagccggccatggccgaggtgcagcttcaggagtcaggacctagcctcgtgaaaccttctcagactctgtccctcacctgttctgtcactggcgactccatcaccaggggttactggagctggatccggaaatccccaggaaataaacttgagtacatggggtacataagctacagtggtagcactttctacaatccatctctcaaaagtcgaatctccatcactcgagacacattcaagaaccagctctacctgcagttgaattctgtgactactgaggacacagccacatattattgtgcagagtacgacgggacttactggggccaagggaccacggtcaccgtctcgagcggtggaggcggttcaggcggaggtggcagcggcggtggcgggtcgacggatattttgatgacccagactccagccaccctgtctgtgactccaggagatagcgtcagtctttcctgcagggccagccaaagtattggcaacaacctacactggtttcaacaaaaatcacatgagtctccaaggcttctcatcaagtatgcttcccagtccatctctgggatcccctccaggttcagtggcagtggatcagggacagatttcactctcagtatcaacactgtggagactgaagattttggaatgtatttctgtcaacagagtaacagctggccgtacacgttcggaggggggacaaagttggaaataaaacgtgcggccgcacatcatcatcaccatcacggggccgc

SEQ ID NO: 9 - protein, 270 aa, Artificial Sequence
  Synthetic polypeptide
MKYLLPTAAAGLLLLAAQPAMAEVQLQESGPSLVKPSQTLSLTCSVTGDSITRGYWSWIRKSPGNKLEYMGYISYSGSTFYNPSLKSRISITRDTFKNQLYLQLNSVTTEDTATYYCAEYDGTYWGQGTTVTVSSGGGGSGGGGSGGGGSTDILMTQTPATLSVTPGDSVSLSCRASQSIGNNLHWFQQKSHESPRLLIKYASQSISGIPSRFSGSGSGTDFTLSINTVETEDFGMYFCQQSNSWPYTFGGGTKLEIKRAAAHHHHHHGA

SEQ ID NO: 10 - DNA, 341 bp, Artificial Sequence
  Synthetic polynucleotide
atggccgaggtgcagcttcaggagtcaggacctagcctcgtgaaaccttctcagactctgtccctcacctgttctgtcactggcgactccatcaccaggggttactggagctggatccggaaatccccaggaaataaacttgagtacatggggtacataagctacagtggtagcactttctacaatccatctctcaaaagtcgaatctccatcactcgagacacattcaagaaccagctctacctgcagttgaattctgtgactactgaggacacagccacatattattgtgcagagtacgacgggacttactggggccaagggaccacggtcaccgtctc

SEQ ID NO: 11 - DNA, 330 bp, Artificial Sequence
  Synthetic polynucleotide
tcgacggatattttgatgacccagactccagccaccctgtctgtgactccaggagatagcgtcagtctttcctgcagggccagccaaagtattggcaacaacctacactggtttcaacaaaaatcacatgagtctccaaggcttctcatcaagtatgcttcccagtccatctctgggatcccctccaggttcagtggcagtggatcagggacagatttcactctcagtatcaacactgtggagactgaagattttggaatgtatttctgtcaacagagtaacagctggccgtacacgttcggaggggggacaaagttggaaataaaacgt

SEQ ID NO: 12 - protein, 551 aa, Artificial Sequence
  Synthetic polypeptide
MKIKTGARILALSALTTMMFSASALAKIEEGKLVIWINGDKGYNGLAEVGKKFEKDTGIKVTVEHPDKLEEKFPQVAATGDGPDIIFWAHDRFGGYAQSGLLAEITPDKAFQDKLYPFTWDAVRYNGKLIAYPIAVEALSLIYNKDLLPNPPKTWEEIPALDKELKAKGKSALMFNLQEPYFTWPLIAADGGYAFKYENGKYDIKDVGVDNAGAKAGLTFLVDLIKNKHMNADTDYSIAEAAFNKGETAMTINGPWAWSNIDTSKVNYGVTVLPTFKGQPSKPFVGVLSAGINAASPNKELAKEFLENYLLTDEGLEAVNKDKPLGAVALKSYEEELAKDPRIAATMENAQKGEIMPNIPQMSAFWYAVRTAVINAASGRQTVDEALKDAQTNSSSNNNNNNNNNNLGPGAAHYVEFAAQPAMADVELQESGPSLVKPSQTLSLTCSVTGDSITRGYWSWIRKFPGNKLEYMGYISYSGSTFYNPSLKSRISITRDTFKNQLYLQLNSVTTEDTATYYCAEYDGTYWGQGTTVTVSSAAAEHHHHHHHHHH

SEQ ID NO: 13 - protein, 548 aa, Artificial Sequence
  Synthetic polypeptide
MKIKTGARILALSALTTMMFSASALAKIEEGKLVIWINGDKGYNGLAEVGKKFEKDTGIKVTVEHPDKLEEKFPQVAATGDGPDIIFWAHDRFGGYAQSGLLAEITPDKAFQDKLYPFTWDAVRYNGKLIAYPIAVEALSLIYNKDLLPNPPKTWEEIPALDKELKAKGKSALMFNLQEPYFTWPLIAADGGYAFKYENGKYDIKDVGVDNAGAKAGLTFLVDLIKNKHMNADTDYSIAEAAFNKGETAMTINGPWAWSNIDTSKVNYGVTVLPTFKGQPSKPFVGVLSAGINAASPNKELAKEFLENYLLTDEGLEAVNKDKPLGAVALKSYEEELAKDPRIAATMENAQKGEIMPNIPQMSAFWYAVRTAVINAASGRQTVDEALKDAQTNSSSNNNNNNNNNNLGPGAAHYVEFAAQPAMASTDILMTQTPATLSVTPGDSVSLSCRASQSIGNNLHWFQQKSHESPRLLIKYASQSISGIPSRFSGSGSGTDFTLSINTVETEDFGMYFCQQSNSWPYTFGGGTKLEIKRAAAEHHHHHHHHHH

SEQ ID NO: 14 - DNA, 348 bp, Artificial Sequence
  Synthetic polynucleotide
gaggtacagctggaggagtctggggctgagtttgtgaaggctggggcttcagtgaagctgtcctgcaagacttctggctacaccttcaacaactactggattcactgggtcaaacagagcccaggacaaggccttgaatggatcggagaaattgatccctctgatggttattctaactacaatcaaaaattcaagggcaaggccacattgactgtggacaagtcctccagcactgcctacatgcacctcaacagtctgacttctgaggactctgcggtctattattgtacaagcagcacttcggtaggaggttcctggggccaagggaccacggtcaccgtctcgagc

SEQ ID NO: 15 - protein, 116 aa, Artificial Sequence
  Synthetic polypeptide
EVQLEESGAEFVKAGASVKLSCKTSGYTFNNYWIHWVKQSPGQGLEWIGEIDPSDGYSNYNQKFKGKATLTVDKSSSTAYMHLNSLTSEDSAVYYCTSSTSVGGSWGQGTTVTVSS

SEQ ID NO: 16 - protein, 544 aa, Artificial Sequence
  Synthetic polypeptide
MKIKTGARILALSALTTMMFSASALAKIEEGKLVIWINGDKGYNGLAEVGKKFEKDTGIKVTVEHPDKLEEKFPQVAATGDGPDIIFWAHDRFGGYAQSGLLAEITPDKAFQDKLYPFTWDAVRYNGKLIAYPIAVEALSLIYNKDLLPNPPKTWEEIPALDKELKAKGKSALMFNLQEPYFTWPLIAADGGYAFKYENGKYDIKDVGVDNAGAKAGLTFLVDLIKNKHMNADTDYSIAEAAFNKGETAMTINGPWAWSNIDTSKVNYGVTVLPTFKGQPSKPFVGVLSAGINAASPNKELAKEFLENYLLTDEGLEAVNKDKPLGAVALKSYEEELAKDPRIAATMENAQKGEIMPNIPQMSAFWYAVRTAVINAASGRQTVDEALKDAQTNSSSNNNNNNNNNNLGPGAAHYVEFAAQPAEVQLEESGAEFVKAGASVKLSCKTSGYTFNSYWIHWIKQSPGQGLEWIGEIDPSDGYTNYNQKFKGKATLTVDKSSSTAYMRLNSLTSEDSAVYYCTSSTSVGGSWGQGTTVTVSSHHHHHH

SEQ ID NO: 17 - protein, 555 aa, Artificial Sequence
  Synthetic polypeptide
MKIKTGARILALSALTTMMFSASALAKIEEGKLVIWINGDKGYNGLAEVGKKFEKDTGIKVTVEHPDKLEEKFPQVAATGDGPDIIFWAHDRFGGYAQSGLLAEITPDKAFQDKLYPFTWDAVRYNGKLIAYPIAVEALSLIYNKDLLPNPPKTWEEIPALDKELKAKGKSALMFNLQEPYFTWPLIAADGGYAFKYENGKYDIKDVGVDNAGAKAGLTFLVDLIKNKHMNADTDYSIAEAAFNKGETAMTINGPWAWSNIDTSKVNYGVTVLPTFKGQPSKPFVGVLSAGINAASPNKELAKEFLENYLLTDEGLEAVNKDKPLGAVALKSYEEELAKDPRIAATMENAQKGEIMPNIPQMSAFWYAVRTAVINAASGRQTVDEALKDAQTNSSSNNNNNNNNNNLGIEGRISEFASTDIELTQSPLSLPVSLGDQASISCTSSQSLLHSNGDTYLHWYLQKPGQSPKLLIYTLSNRFSGVPDRFSGSGSGTDFTLKISRVEAADLGIYFCSQTTHVPYTFGGGTKLEIKRHHHHHHGAAEQKLISEEDLNGAA

SEQ ID NO: 18 - protein, 7 aa, Artificial Sequence
  Synthetic oligopeptide
RRFYGPY

(19) United States
(12) Patent Application Publication
(10) Pub. No.: US 2011/0237462 A1
(43) Pub. Date: Sep. 29, 2011

(54) IMMOBILIZATION SUBSTRATE AND METHOD FOR PRODUCING THE SAME

(75) Inventors: Koichi Minami, Kanagawa (JP); Hirohiko Tsuzuki, Kanagawa (JP); Hiroshi Ueda, Tokyo (JP); Masaki Ihara, Tokyo (JP)

(73) Assignees: FUJIFILM CORPORATION, Minato-ku, Tokyo (JP); THE UNIVERSITY OF TOKYO, Bunkyo-ku, Tokyo (JP)

(21) Appl. No.: 13/132,834

(22) PCT Filed: Dec. 4, 2009
(86) PCT No.: PCT/JP2009/070716

§ 371 Date: Jun. 3, 2011

(30) Foreign Application Priority Data
Dec. 4, 2008 (JP) 2008-309839
May 13, 2009 (JP) 2009-117081

(51) Int. Cl. C40B 40/10; C40B 50/14

(52) U.S. Cl. 506/18; 506/30

(57) ABSTRACT

An antibody-fragment-immobilizing substrate includes a substrate and at least one set of antibody fragments, wherein antibody fragments of each set include at least two types of separate antibody fragments, the at least two types of separate antibody fragments include at least one type of labeled antibody fragment having a labeled site labeled with a luminescent substance and at least one type of acceptor antibody fragment having an acceptor site for accepting emission from the labeled antibody fragment, and the at least one type of labeled antibody fragment and the at least one type of acceptor antibody fragment are capable of cooperatively recognizing one type of antigen in combination and are independently immobilized on the substrate in a positional relationship that allows each of the antibody fragments in one set to bind to the same antigen.

### TECHNICAL FIELD

The invention relates to an immobilization substrate and a method for producing the immobilization substrate.

### BACKGROUND ART

An immunoassay such as an ELISA is well known as a system which can precisely detect various target proteins. The immunoassay uses a protein and a specific antibody against this protein as a target substance and a detection substance, respectively, and detects the target substance with high sensitivity based on a specific interaction between these substances. The ELISA has undergone various improvements in consideration of sensitivity and operability. In recent years, an assay for detecting a large quantity of samples conveniently and with high sensitivity in a short time has been demanded.

A molecular imprinting technique is another system that effectively uses such a specific binding reaction between a target substance and a detection substance.

For example, Japanese Patent Application Laid-Open (JP-A) No. 2006-138656 discloses a molecular imprinting gel obtained by reacting a complex composed of a monomer or polymer introducing a ligand for a target molecule and the target molecule with a polymer cross linking agent to make a gel containing the complex composed of the ligand and the target molecule, and removing the target molecule from the gel. Furthermore, JP-A No. 2006-138656 discloses that, when an antigen AFP is added to a gel substrate including an anti-AFP antibody and lectin, the gel is shrunk due to the binding of AFP to the anti-AFP antibody and lectin, and that the presence of AFP (target molecule) can be detected by such swelling and shrinking of the gel.

However, in the molecular imprinting method described above, since an immobilization substrate is formed by immobilizing an antigen-antibody complex by polymerization, the antigen to be detected must penetrate into a cross-linked gel matrix structure in order to reach the antibody. Thus it takes time for the antigen to react with the antibody, thereby requiring contacting a highly concentrated antigen with the substrate for two to four hours in order for a substance to be surely recognized. Furthermore, when the antigen is washed away and removed, efficient washing cannot be attained due to the same reason as above, whereby responsiveness after removal tends to be decreased. Therefore, rapid and highly sensitive detection cannot be achieved.

In addition to the above-described technique, as a system using a specific binding based on the antigen-antibody reaction, an immunoassay reagent that utilizes fluorescence resonance energy transfer between two types of fluoresce-labeled antibody fragments is disclosed in JP-A No. 10-78436. In this immunoassay reagent, when an antigen is absent, an antigen-antibody complex is not formed and thus fluorescence resonance energy transfer (FRET) does not occur. On the other hand, when an antigen is present, an antigen-antibody complex is formed and thus FRET occurs. Therefore, the presence of an antigen can be detected rapidly and simply. However, in this reagent, since the antigen and the antibody fragment are not immobilized onto the substrate, the antigen and the antibody fragment may wash out or disperse due to the washing operation or the like. Therefore, the reagent is for one use only, and it is difficult to apply the reagent for repeated use. Even when these antibody fragments are simply immobilized on a substrate in order to use the reagent repeatedly, it is difficult to locate a luminescent substance and a luminescence recognizing substance in an adjacent position on the substrate. When the immobilization amount is increased in order to locate these substances in an adjacent position, a large quantity of luminescent substance and luminescence recognizing substance are adjacently located, which may result in an extremely poor S/N ratio.

In order to avoid the problem described above, JP-A No. 2007-40834 discloses a method in which two antibody fragments are connected via a linker. In this method, while the antibody fragments can be immobilized in an adjacent position, the linker must be designed for every antibody fragment and antigen such that two antibodies can function effectively. Therefore, this method lacks versatility, thereby increasing the production costs.

As a simple detection system that can be repeatedly used, JP-A No. 2008-83042 discloses a reusable biosensor using a molecular recognition element and a nano particle. However, since the linker must be designed, this technique lacks versatility and requires much labor.

Further, as a simple detection system which can be repeatedly used, the Abstracts of the 57th Annual Meeting of the Japan Society for Analytical Chemistry (2008) p. 97 E3017 discloses a detection system using a substrate onto which an antibody labeled with a hydrophobic field-responsive fluorescent substance is immobilized. However, in this system, the hydrophobic field must be formed at an interface between an antigen and an antibody upon antigen recognition. Therefore, this system is limited only to a specific combination of antigen and antibody, and thus lacks versatility. In addition, the fluorescent substance needs to be labeled adjacent to the antigen recognition site of the antibody, which requires a highly sophisticated design. Therefore, this system requires high costs and much labor.

### SUMMARY OF INVENTION

Any of the above-described techniques are not sufficient as a substrate for detecting a test substance that can precisely and simply detect a target molecule in a short time and that can be repeatedly used after washing.

In order to use such substrate for a biosensor, a manufacturing method with greater versatility has also been required, form the viewpoint of the production costs.

The present invention has been made in consideration of the above-described circumstances. The present invention provides an immobilization substrate that can precisely and simply detect a targeted molecule in a short time and that can be repeatedly used after washing.

The present invention also provides a method that can efficiently produce an immobilization substrate having greater versatility.

The present invention includes the following aspects:

<1> An antibody-fragment-immobilizing substrate including a substrate and at least one set of antibody fragments,

wherein antibody fragments of each set include at least two types of separate antibody fragments,

the at least two types of separate antibody fragments include at least one type of labeled antibody fragment having a labeled site labeled with a luminescent substance and at least one type of acceptor antibody fragment having an acceptor site for accepting emission from the labeled antibody fragment, and

the at least one type of labeled antibody fragment and the at least one type of acceptor antibody fragment are capable of cooperatively recognizing one type of antigen and are independently immobilized on the substrate in a positional relationship that allows each of the antibody fragments in one set to bind to the same antigen.

<2> The antibody-fragment-immobilizing substrate according to <1>, wherein the at least two types of antibody fragments includes a VH-region polypeptide and a VL-region polypeptide.

<3> The antibody-fragment-immobilizing substrate according to <1> or <2>, further including a polymer layer and wherein the at least two types of antibody fragments are immobilized on the polymer layer.

<4> The antibody-fragment-immobilizing substrate according to <3>, wherein the thickness of the polymer layer is from 1 nm to 0.5 mm.

<5> The antibody-fragment-immobilizing substrate according to <3> or <4>, wherein the polymer layer is bound to the substrate through a self-assembled monolayer.

<6> The antibody-fragment-immobilizing substrate according <5>, wherein the thickness of the self-assembled monolayer is from 0.2 nm to 10 μm.

<7> The antibody-fragment-immobilizing substrate according to any one of <3> to <6>, wherein the polymer is a polysaccharide.

<8> The antibody-fragment-immobilizing substrate according to any one of <1> to <7>, wherein the luminescent substance is at least one selected from a fluorescent dye or a fluorescent protein.

<9> The antibody-fragment-immobilizing substrate according to any one of <1> to <8>, wherein a fluorescence resonance energy transfer occurs between the labeled antibody fragment and the acceptor antibody fragment.

<10> The antibody-fragment-immobilizing substrate according to any one of <1> to <9>, which is used for a bioreactor or biosensor based on a binding reaction between the at least two types of antibody fragments and the antigen.

<11> A method for producing an antibody-fragment-immobilizing substrate including:

contacting separate antibody fragments of at least two types that include at least one type of labeled antibody fragment having a labeled site labeled with a luminescent substance and at least one type of acceptor antibody fragment having an acceptor site for accepting emission from the labeled antibody fragment and that are capable of cooperatively recognizing one type of antigen, with the antigen, and forming a complex whereby each of the antibody fragments binds to the antigen;

immobilizing the complex on a substrate via the antibody fragments in the complex; and

removing the antigen from the complex to obtain the antibody-fragment-immobilizing substrate, wherein the antibody fragments are independently immobilized on the substrate in a positional relationship that allows each of the antibody fragments to bind to the same antigen.

<12> The method for producing the antibody-fragment-immobilizing substrate according to <11>, wherein the antibody fragments include a VH-region polypeptide and a VL-region polypeptide.

<13> The method for producing the antibody-fragment-immobilizing substrate according to <11> or <12>, wherein the contacting includes mixing the antibody fragments and the antigen such that the ratio of the number of antigens to the valencies of molecules formed by a combination of antibody fragments is from 0.1:1 to 10:1.

<14> The method for producing the antibody-fragment-immobilizing substrate according to any one of <11> to <13>, wherein the removing is performed such that reduces the avidity of the antibody fragments and the antigen in the complex is reduced.

According to the present invention, an antibody-fragment-immobilizing substrate that can precisely and simply detect a targeted molecule in a short time and that can be repeatedly used after washing is provided. The present invention also provides a method that can efficiently produce an antibody-fragment-immobilizing substrate having greater versatility.

### BRIEF DESCRIPTION OF DRAWINGS

FIGS. 1A and 1B is a schematic diagram illustrating an example of the immobilization substrate according to the present invention. FIG. 1A represents a schematic diagram of the immobilization substrate in the absence of the antigen. FIG. 1B represents a schematic diagram of the immobilization substrate in the presence of the antigen.

FIG. 2 is a scheme for preparing the expression vectors according to Examples described in the present invention.

### MODES FOR CARRYING OUT THE INVENTION

The immobilization substrate according to the present invention is an antibody-fragment-immobilizing substrate including a substrate and at least one set of antibody fragments, wherein antibody fragments of each set include at least two types of separate antibody fragments, the at least two types of separate antibody fragments include at least one type of labeled antibody fragment having a labeled site labeled with a luminescent substance and at least one type of acceptor antibody fragment having an acceptor site for accepting emission from the at least one type of labeled antibody fragment, and the at least one type of labeled antibody fragment and the at least one type of acceptor antibody fragment are capable of cooperatively recognizing one type of antigen and are independently immobilized on the substrate in a positional relationship that allows each of the antibody fragments in one set to bind to the same antigen.

In an embodiment, the immobilization substrate according to the present invention is an antibody-fragment-immobilizing substrate including a substrate and at least one set of antibody fragments, wherein the antibody fragments of each set include at least two different and separate antibody fragments that include at least one labeled antibody fragment having a labeled site labeled with a luminescent substance and at least one acceptor antibody fragment having an acceptor site for accepting emission from the at least one type of labeled antibody fragment, and the at least one labeled antibody fragment and the at least one acceptor antibody fragment are capable of cooperatively recognizing one type of antigen and are independently immobilized on the substrate in a positional relationship allowing each of the antibody fragments in one set to bind to the same antigen. For example, the present invention provides an immobilization substrate, on which at least two types of separate antibody fragments that include at least one type of labeled antibody fragment having a labeled site labeled with a luminescent substance and at least one type of acceptor antibody fragment having an acceptor site for accepting emission from the at least one type of labeled antibody fragment and that are capable of cooperatively recognizing one type of antigen are independently immobilized on a positional relationship that allows each of the antibody fragments to bind to the antigen.

More specifically, the antibody-fragment-immobilizing substrate may include, for example, a substrate and at least one (for example two or more) antibody-fragment set consisting of two or more different and separate antibody fragments that include at least one type of labeled antibody fragment having a labeled site labeled with a luminescent substance and at least one type of acceptor antibody fragment having an acceptor site for accepting emission from the at least one type of labeled antibody fragment and that are capable of recognizing one antigen, are independently immobilized on the substrate in a positional relationship whereby each of the two or more antibody fragments are capable of binding to the same antigen molecule or anything that forms a single antigen-bearing entity. Therefore, the antibody-fragment-immobilizing substrate of the present invention may include two or more such antibody-fragment sets that may bind to the same antigen-presenting entity or respectively different antigen-presenting entities.

Here, the “separate antibody fragments” represent antibody fragments that are not linked to each other (for example, by disulfide bonds).

In the antibody-fragment-immobilizing substrate according to the present invention, since at least two separate antibody fragments that are capable of recognizing one antigen are independently immobilized on the substrate in a positional relationship allowing the at least two separate antibody fragments in one set to bind the same antigen, the antibody fragments in one set are independent of one another and are placed on the substrate at positions adjacent to one another. Antibody fragments such as these that cooperatively recognize the antigen can exhibit a higher affinity than antibody fragments that are randomly immobilized. In addition, since the each of the antibody fragments are independently immobilized on the substrate in a positional relationship allowing the at least two separate antibody fragments in one set bind to the same antigen, and since each antibody fragment is bound to the substrate through a part of the antibody, a moiety having the antigen recognition site is allowed to move such a degree that it can bind to the antigen. Therefore, when the antigen exists, each antibody fragment in one set can easily approach the antigen and can cooperatively bind to the antigen in a short time. Since dispersion or washing away of the respective antibody fragments during washing can be suppressed, the substrate can be used for repeated measurement. Further, since antibody fragments in one set form a complex with an antigen and are immobilized to the substrate as a complex, antibody fragments constituting different complexes may be placed on the substrate at positions nonadjacent to one another. Therefore, even in an immobilization substrate for measuring multiple test substances simultaneously, the antibody fragments in one set are at positions on the substrate nonadjacent to other sets of antibody fragments which recognize a different antigen, thereby cross talk between antibody fragments, which is usually problematic in ELISA, can be suppressed.

Furthermore, on the immobilization substrate according to the present invention, at least two types of antibody fragments are immobilized, the at least two types of antibody fragments include at least one type of labeled antibody fragment having an labeled site labeled with the luminescent substance and at least one acceptor antibody fragment having an acceptor site accepting emission from the at least one type of labeled antibody fragment, and the at least one type of labeled antibody fragment and the at least one acceptor antibody fragment are capable of cooperatively recognizing one type of antigen. Therefore, when the antigen exists, the at least one type of labeled antibody fragment and the at least one type of acceptor antibody fragment approach one another, whereby a reaction based on luminescence, such as FRET or BRET, easily occurs between these antibody fragments. Based on such a reaction, precise and simple detection of antigens can be performed in a short time.

Although prior documents disclose two types of antibodies that are connected by a linker, the distance between these antibodies varies depending on a combination of the antigen and antibody to be used, and thus a suitable linker depending on the type of the antigen must be designed. In addition, regarding the labeling with a luminescent substance, the luminescent substance and an emission-accepting substance need to be selectively labeled with the same molecule, thereby requiring very high costs and a large amount of labor for production. On the other hand, the present invention does not require connecting the two types of the antibody fragments with a linker, and thus can be applied for any antigen-antibody combination. In addition, in the present invention, antibodies can be labeled independently. Therefore, the method according to the present invention has greater versatility and is particularly suitable for production.

Hereinafter, the present invention is further described.

(1) Immobilization Substrate

(1) Substrate

Preferable examples of the substrate of the invention include a substrate in which a functional group is added to any of the following materials: metal oxides such as an optical glass (for example, BK7), silica, alumina, titania, zirconia and indium tin oxide (ITO); metal nitrides such as silicon nitride, gallium nitride, aluminum nitride and indium nitride; and synthetic resins, specifically a resin such as Sepharose (tradename), polyethylene, polystyrene, poly(meth)acrylic acid, poly(meth)acrylamide, poly methyl(meth)acrylate, polyethylene terephthalate, polycarbonate or a cyclo-olefin polymer. Among these, materials transparent against a light source, such as glass, ITO, polymethyl(meth)acrylate, polyethylene terephthalate, polycarbonate or a cyclo-olefin polymer are preferable. Examples of the functional group include an amino group, a carboxy group, a maleimide group, an aldehyde group, a succinimide group, a thiol group, a hydrazine group, an isocyanate group, an epoxy group, a vinyl sulfone group, a vinyl group, and a cyano group.

The substrate is preferably a material that is not anisotropic under polarized light and has excellent workability.

Examples of a method for adding these functional groups include a known method of treating a surface such as plasma treatment, ozone treatment, etching treatment using an acid and/or alkali, or a method using a self-assembled monolayer. From the viewpoint of production suitability, a method using the self-assembled monolayer is preferable.

(2) Polymer Layer

A polymer layer may be formed on the substrate of the present invention. Examples of a polymer constituting the polymer layer include a hydrophilic polymer, a hydrophobic polymer and a combination thereof. The polymer layer is preferably a layer consisting essentially of a hydrophilic polymer. The polymer layer may be directly linked to the substrate or may be indirectly linked to the substrate. Examples of a method of direct linking of the polymer layer to the substrate include a method in which a polymer is linked to a substrate via graft polymerization on the substrate. Examples of a method of indirect linking of the polymer layer include a method in which a hydrophobic polymer is applied onto a substrate, and then a hydrophilic polymer is linked to the hydrophobic polymer, and a method in which a compound capable of binding to the substrate and a polymer (hereinafter, sometimes referred to as a linker) is provided on the surface of the substrate, and then the polymer is linked to the compound. In one preferable embodiment, a self-assembled monolayer is used as a linker, and a hydrophilic polymer is linked to a glass substrate via the self-assembled monolayer. Hereinafter, this embodiment is described in detail. Examples of a method of forming the self-assembled monolayer include (2-1) a method using a silane coupling agent and (2-2) a method using alkanethiol. Each method will be described below.

(2-1) The Method Using a Silane Coupling Agent

In the method using the silane coupling agent, by providing a silane coupling agent described below to the substrate described above, the self-assembled monolayer can be formed by the silane coupling agent, whereby the functional groups are provided on the substrate.

As the silane coupling agent that can be used in the present invention, a silicon-containing compound represented by the following Formula A-1 may be used to form a covalent bond such as substrate-oxygen-silicon-carbon, thereby providing the functional groups to the substrate surface. In Formula A-1, X^{a} represents a functional group; L^{a} represents a linker moiety such as a linear, branched or cyclic carbon chain; R^{a} represents hydrogen or an alkyl group having 1 to 6 carbon atoms; Y^{a} represents a hydrolyzable group; m and n each independently represent an integer of from 0 to 3, and the total of m and n is 3.

C^{a}-L^{a}-Si—(R^{a}ₘ)Y^{a}ₙ Formula A-1

Examples of the hydrolyzable group (Y^{a}) include an alkoxy group, a halogen group and an acyloxy group. More specifically, examples of the hydrolyzable group (Y^{a}) include a methoxy group, an ethoxy group and chlorine.

Specific examples of the silane coupling agent include γ-aminopropyl trimethoxysilane, N-β-(aminoethyl)-γ-aminopropyl trimethoxysilane, γ-aminopropyl methyldiethoxysilane, γ-mercaptopropyl trimethoxysilane, and γ-glycidoxypropyltriethoxysilane. Examples of the reaction method of the silane coupling agent include a general method such as a method described in “Effects and usages of silane coupling agents” (Science & Technology Co., Ltd.).

Examples of the functional group (X^{a}) of the silane coupling agent are not limited as long as the functional group (X^{a}) can bind to the below-described polymer and/or complex. Examples thereof include functional groups such as an amino group, a carboxyl group, a hydroxyl group, an aldehyde group, a thiol group, an isocyanate group, an isothiocyanate group, an epoxy group, a cyano group, a hydrazino group, a hydrazide group, a vinyl sulfone group, a vinyl group and a maleimide group. A combination of these functional groups or a derivative thereof may also be used. Among these, functional group (X^{a}) is preferably an amino group or an epoxy group.

(2-2) The Method Using Alkanethiol

In the method using alkanethiol, a metal film is disposed on a surface of the substrate described above, and then the alkanethiol is provided thereon. Here, “disposed on a surface of the substrate” means a case whereby the metal film is disposed on a surface of the substrate such that it directly comes into contact with the substrate, as well as a case whereby the metal film is disposed via another layer without directly coming into contact with a surface of the substrate.

These metals can be used singly or in combination of two or more kinds thereof. Moreover, in consideration of adherability to the substrate described above, an intermediate layer including chrome or the like may be provided between the substrate and the metal film.

The film thickness of the metal film is not particularly limited, and preferably from 0.1 nm to 1 mm, and more preferably from 1 nm to 1 μm. When the film thickness exceeds 1 mm, production cost increases. Moreover, when the intermediate layer including chrome or the like is provided, the thickness of the intermediate layer is preferably from 0.1 nm to 10 nm.

A method of coating a metal film using alkanethiol has been intensively studied by Professor Whitesides at Harvard University, and the details thereof are described in Chemical Review, 105, 1103-1169 (2005), for example. When gold is used as the metal, an alkanethiol represented by the following Formula A-2 (wherein n represents an integer of from 3 to 20, and X^{b} represents a functional group) may be used as an organic layer-forming compound, whereby a monomolecular film having an orientation can be formed in a self-assemble manner based on an Au-S bond and the van der Waals force between alkyl chains. A self-assembled monolayer may be produced by an extremely easy method, which includes immersion of a gold substrate in a solution of an alkanethiol derivative. More specially, functional groups can be provided to a surface of the substrate, for example, by forming a self-assembled monolayer using a compound in which X^{b} in Formula A-2 represents an amino group, a carboxyl group, a hydroxyl group, an aldehyde group, a thiol group, an isocyanate group, an isothiocyanate group, an epoxy group, a cyano group, a hydrazino group, a hydrazide group, a vinyl sulfone group, a vinyl group or a maleimide group.

HS(CH₂)ₙX^{b} A-2

In Formula A-2, the number of repetition of an alkylene group, n, is preferably an integer of from 3 to 16, and more preferably an integer of from 4 to 8. The alkylene moiety may be substituted with a multiple bond or a hetero atom such as nitrogen or oxygen. When the alkyl chain of the alkanethiol derivative is too short, formation of the self-assembled monolayer is difficult. When the alkyl chain of the alkanethiol derivative is too long, water solubility is decreased and thus handling thereof is difficult.

A self-assembled monolayer can be formed with a single kind of alkanethiol of Formula A-2 (that is, an alkanethiol having one type of the functional group X^{b}). A self-assembled monolayer can also be formed from a mixture of two or more kinds of alkanethiols.

The film thickness of the self-assembled monolayer is not particularly limited, and is preferably from 0.2 nm to 10 more preferably from 1 nm to 500 nm, and still more preferably from 5 nm to 50 nm. When the film thickness is 10 μm or less, a test substance can easily diffuse into the monolayer. When the film thickness is 0.2 nm or more, the immobilization amount of a substance to be immobilized on the substrate can be increased.

In the present invention, the antibody fragments may be directly immobilized to the self-assembled monolayer. However, in order to improve the antigen-binding efficiency of the antibody fragments, it is preferable to form a polymer layer on the self-assembled monolayer so as to provide functional groups for immobilizing the antibody fragments on the substrate surface. The polymer used in the invention is preferably a hydrophilic polymer, and specific examples thereof include gelatin, agarose, chitosan, dextran, carrageenan, alginic acid, starch, cellulose, or derivatives thereof such as carboxymethyl derivative, and water-swellable organic polymers (for example, polyvinyl alcohol, polyacrylic acid, polyacrylamide, polyethylene glycol and derivatives thereof).

Preferable examples of the hydrophilic polymer that can be used in the invention include a carboxyl group-containing synthetic polymer and a carboxyl group-containing polysaccharide. Examples of the carboxyl group-containing synthetic polymer include polyacrylic acid, polymethacrylic acid and copolymers thereof. Further examples include a methacrylic acid copolymer, an acrylic acid copolymer, an itaconic acid copolymer, a crotonic acid copolymer, a maleic acid copolymer, a partially esterified maleic acid copolymer and a hydroxyl group-containing polymer in which an acid anhydride has been added thereto, such as those disclosed, for example, in JP-A No. 59-53836, from line 2, upper right column on page 3, to line 9, lower left column on page 6, and JP-A No. 59-71048, from line 1, lower left column on page 3, to line 3, upper left column on page 5.

Examples of the carboxyl group-containing polysaccharide include any one selected from extracts from natural plants, products obtained by fermentation by microorganisms, synthetic products obtained by enzymes and chemically synthetic products. Specific examples thereof include hyaluronic acid, chondroitin sulfate, heparin, dermatan sulfate, carboxymethyl cellulose, carboxyethyl cellulose, cellouronic acid, carboxymethyl chitin, carboxymethyl dextran, and carboxymethyl starch. As a carboxyl group-containing polysaccharide, a commercially available product can also be used. Specific examples thereof include carboxymethyl dextrans such as CMD, CMD-L and CMD-D40 (trade names, all manufactured by Meito Sangyo Co., Ltd.), sodium carboxymethylcellulose (manufactured by Wako Pure Chemical Industries, Ltd.) and sodium alginate (manufactured by Wako Pure Chemical Industries, Ltd.).

The molecular weight of the hydrophilic polymer used in the invention is not particularly limited. In general, the weight average molecular weight is preferably from 2×10² to 5×10⁶, and more preferably from 1×10⁴ to 2×10⁶. When the weight average molecular weight is less than the above range, the immobilization amount of the antibody fragments on the substrate may be reduced. A weight average molecular weight greater than the above range may result in high solution viscosity, thereby making the handling thereof difficult.

The thickness of the polymer layer in an aqueous solution is preferably from 1 nm to 0.5 mm, more preferably from 1 nm to 1 μm, and still more preferably from 100 nm to 500 nm. When the thickness is less than the above range, the immobilized amount of a physiologically active substance reduces, which makes interaction of the physiologically active substance with a test substance less likely to occur. When the film thickness exceeds the above range, the uniformity of the polymer layer may not be maintained, and a test substance may be inhibited from diffusing into the polymer film. In particular, when the interaction is detected from the side of a sensor substrate opposite to a hydrophilic polymer-immobilized surface thereof, the detection sensitivity may be decreased due to the long distance from the detection surface to an interaction-forming part.

The thickness of the hydrophilic polymer in an aqueous solution can be evaluated by, for example, AFM or ellipsometry.

When the carboxyl group-containing polymer is used, the complex can be immobilized on the substrate via functional groups provided to the substrate surface by activating carboxyl groups of the polymer. Examples of the method for activating the carboxyl group-containing polymer include a known method, for example, a method in which a carboxyl group-containing polymer is activated by using a water-soluble carbodiimide such as 1-(3-dimethylaminopropyl)-3-ethylcarbodiimide (EDC) and N-hydroxysuccinimide (NHS), and a method in which a carboxyl group-containing polymer is activated by using EDC alone. The polymer having the carboxyl group activated by using these methods can be reacted with the substance having an amino group so as to attach the hydrophilic polymer to the substrate.

Examples of the method for activating the carboxyl group-containing polymer also include a method using a nitrogen-containing compound. Specific examples of the nitrogen-containing compound include a compound represented by the following Formula (Ia) or Formula (Ib) (wherein, R¹ and R² each independently represent an unsubstituted or substituted carbonyl group, a carbon atom which may have a substituent, or a nitrogen atom which may have a substituent; R¹ and R² may be linked to each other to form a 5- or 6-membered ring; A represents a carbon atom having a substituent, or a phosphorus atom having a substituent; M represents an element which forms an (n-1)-valent counter ion as a whole; and X represents a halogen atom).

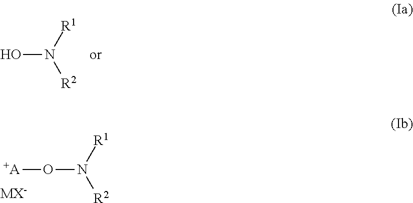

In Formulae (Ia) and (Ib), R¹ and R² each independently represent an unsubstituted or substituted carbonyl group, a carbon atom which may have a substituent, or a nitrogen atom which may have a substituent, and preferably R¹ and R² are linked to each other to form a 5- or 6-membered ring. Preferable examples of the nitrogen-containing compound include hydroxysuccinimide, hydroxyphthalimide, 1-hydroxybenzotriazole, 3,4-dihydroxy-3-hydroxy-4-oxo-1,2,3-benzotriazine, and derivatives thereof.

Preferable examples of the nitrogen-containing compound also include the following compounds (Ic), (Id) and (Ie).

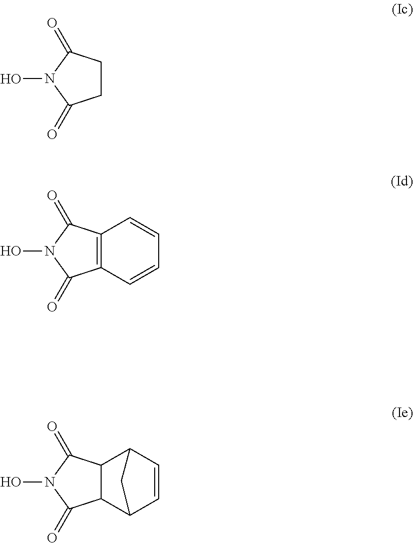

Preferable examples of the nitrogen-containing compound include a compound represented by the following Formula (II) (wherein, Y and Z each independently represent CH or a nitrogen atom).

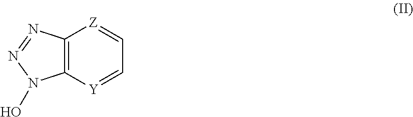

Preferable examples of the compound represented by Formula (II) include the following compounds (II-1) to (II-3).

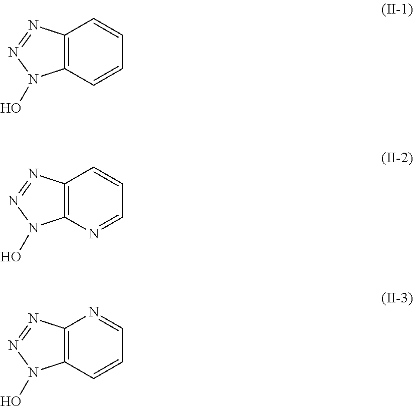

Preferable examples of the nitrogen-containing compound also include a compound represented by the following Formula (II-4).

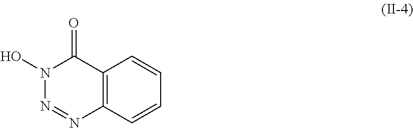

Preferable examples of the nitrogen-containing compound further include a compound represented by the following Formula (III) (wherein A represents a carbon atom having a substituent, or a phosphorus atom having a substituent; Y and Z each independently represent CH or a nitrogen atom; M represents an element which forms an (n-1)-valent counter ion as a whole; and X represents a halogen atom).

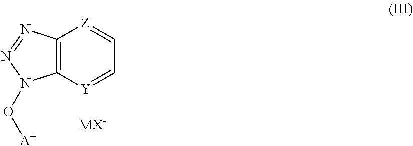

In Formula (III), the substituent which the carbon atom or phosphorus atom represented by A has is preferably an amino group having a substituent. More specifically, a dialkylamino group such as a dimethylamino group or a pyrrolidino group is preferable. Examples of the element represented by M include a phosphorus atom, a boron atom and an arsenic atom. Among these, a phosphorus atom is preferable. Examples of the halogen atom represented by X include a fluorine atom, a chlorine atom, a bromine atom and an iodine atom. Among these, a fluorine atom is preferable.

Specific examples of the nitrogen-containing compound represented by Formula (III) include the following compounds (III-1) to (III-6).

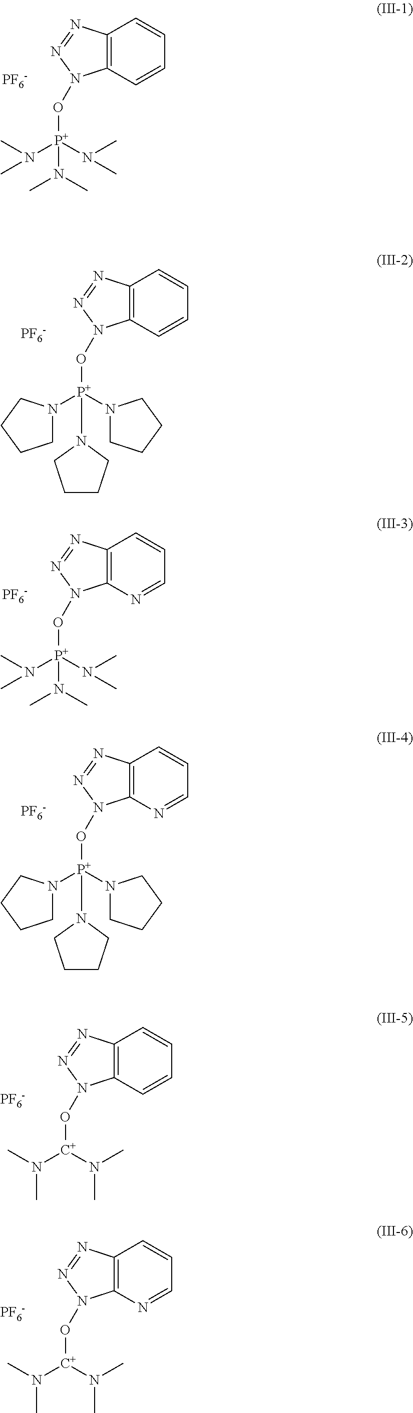

Preferable examples of the nitrogen-containing compound further include a compound represented by the following Formula (IV) (wherein A represents a carbon atom having a substituent, or a phosphorus atom having a substituent; M represents an element which forms an (n-1)-valent counter ion as a whole; and X represents a halogen atom).

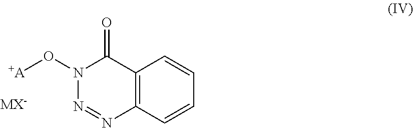

Preferable examples of the nitrogen-containing compound represented by Formula (IV) include the following compound (IV-1).

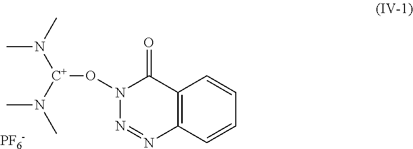

Examples of the method for activating the carboxyl group-containing polymer also include a method using a phenol derivative having an electron-withdrawing group. The σ value of the electron-withdrawing group is preferably 0.3 or more. Specific examples of the phenol derivative having an electron-withdrawing group include the following compounds (V-1) to (V-4).

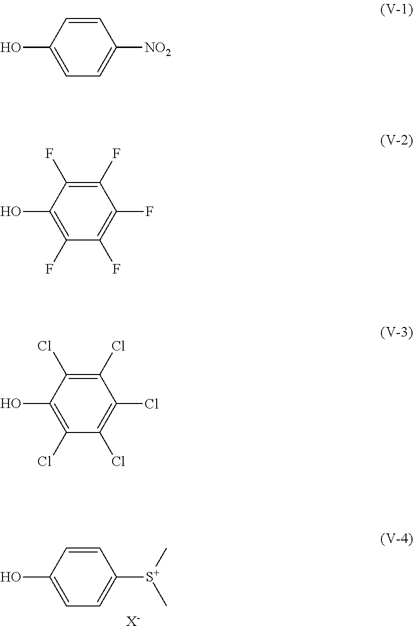

Any of the above-described carbodiimide derivative, nitrogen-containing compound and phenol derivative may be used singly, or in combination of two or more kinds thereof, if desired. It is preferable to use the carbodiimide derivative and the nitrogen-containing compound in combination.

Examples of the method for activating the carboxyl group-containing polymer further include a method using the following compound (V-6). The compound (V-6) may be used singly, or in combination with the carbodiimide derivative, the nitrogen-containing compound and/or the phenol derivative.

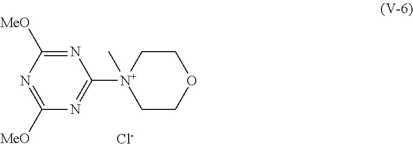

In addition, preferable examples of the method for activating the carboxyl group of the carboxyl group-containing polymer include methods such as that described in paragraph Nos. [0011] to [0022] of JP-A No.2006-58071 (i.e., a method of forming a carboxylic acid amide group by activating the carboxyl group on a surface of a substrate with a compound selected from a uronium salt having a particular structure, a phosphonium salt having a particular structure or a triazine derivative having a particular structure); and methods such as that described in paragraph Nos. [0011] to of JP-A No.2006-90781 (i.e., a method of forming a carboxylic acid amide group by activating the carboxyl group on a surface of a substrate with a carbodiimide derivative or a salt thereof, converting the activated group to an ester group using a nitrogen-containing heteroaromatic compound having a hydroxyl group, a phenol derivative having an electron-withdrawing group or an aromatic compound having a thiol group, and then reacting the resulting ester group with an amine).

The polymer containing an activated carboxyl group may be prepared as a polymer solution and reacted with the substrate. Alternatively, the polymer containing an activated carboxyl group of the present invention may be formed in a thin film on the substrate by using a method such as a spin coating method, and reacted with the substrate in the thin film state. The polymer is preferably reacted in the thin film state with the substrate.

As described above, the polymer of the invention is preferably reacted in the thin film state with the substrate. As a method for forming a thin film on the substrate, known methods can be used. Specific examples of such methods that can be used include an extrusion coating method, a curtain coating method, a casting method, a screen printing method, a spin coating method, a spray coating method, a slide bead coating method, a slit and spin method, a slit coating method, a die coating method, a dip coating method, a knife coating method, a blade coating method, a flow coating method, a roll coating method, a wire-bar coating method, and a transfer printing method. These methods are described in, for example, “Progress in Coating Technology (Coating Gijutsu no Shinpo)” written by Yuji Harazaki, Sogo Gijyutsu Center (1988); “Coating Technology (Coating Gijutsu)” Technical Information Institute Co., Ltd. (1999); “Aqueous Coating Technology (Suisei Coating no Gijutsu)” CMC (2001); “Evolving Organic Thin Film: Edition for Deposition (Shinka-suru Yuuki Hakumaku: Seimaku hen)” Sumibe Techno Research Co., Ltd. (2004); and “Polymer Surface Processing Technology (Polymer Hyomen Kako Gaku)” written by Akira Iwamori, Gihodo Shuppan Co., Ltd. (2005). In the present invention, the method for forming a thin film on the substrate is preferably a spray coating method or a spin coating method, and more preferably a spin coating method, since a coating film having a controlled film thickness can be readily produced by such a method.

(2) Antibody Fragment

In the present invention, at least one type of labeled antibody fragment having a labeled site labeled with a luminescent substance and at least one type of acceptor antibody fragment having an acceptor site for accepting emission from the labeled antibody fragment in one set cooperatively recognize one type of antigen

The antibody-fragment immobilization substrate of the present invention is not particularly limited as long as at least one antibody-fragment set containing the labeled and acceptor antibody fragments capable of recognizing one type of antigen is immobilized thereon. Plural types of antibody-fragment sets each consisting of such antibody fragments may be immobilized on the substrate. By using the plural types of antibody-fragment sets, plural types of antigens can be recognized with one immobilization substrate.

The type of the antigen is not specifically restricted as long as it can interact with an antibody, and can be appropriately selected depending on the target substance to be detected. Further, the antibody fragment can be appropriately selected as an antibody capable of interacting with such an antigen.

Any antibodies can be used as long as antibody fragments of two or more types can individually or cooperatively recognize and bind to one antigen. Examples of such plural antibody fragments include two or more types of antibody fragments each having at least a part of an antigen recognition site for (the same) one epitope on one type of antigen, two or more types of antibody fragments each having an antigen recognition site for a different epitope on one type of antigen, and antibody fragments each having any one of plural hypervariable regions for one epitope. Such plural antibody fragments can also be used in combination, as long as the antibodies recognize one antigen.

Preferable examples of the antibody fragment of the invention include a VH-region polypeptide and VL-region polypeptide, from the viewpoint of an antigen binding ability. The antibody fragment of the invention is more preferably a combination of a VH-region polypeptide and VL-region polypeptide, from the viewpoint of an antigen binding ability and versatility. The combination is not specifically limited, as long as one of a VH-region polypeptide or a VL-region polypeptide is used as a labeled antibody fragment and the other one is used as an acceptor antibody fragment.

The length of VH-region polypeptide and VL-region polypeptide may be either longer or shorter than the VH region and VL region of the antibody, respectively, as long as they can bind to a target antigen in association with each other. These polypeptides can be produced from a monoclonal antibody made by a hybridoma technique by using a conventional method. For example, the polypeptides can be obtained as follows.

First, a monoclonal antibody capable of recognizing a desired test substance is produced by a known method. The gene encoding the variable region of this antibody is then specified by a method using a cDNA library and hybridization technique, followed by cloning this gene into a vector. The sequence encoding the VH and/or VL region is then obtained from this recombinant vector, and this sequence fragment is subcloned into an expression vector. By expressing this gene in host cells, the required amount of VH and/or VL can be obtained.

In order to obtain the VH/VL coding sequence from the antibody gene, the desired sequence region may be isolated by cleavage with a restriction enzyme and amplified it using a cloning vector, or the desired sequence may be amplified by PCR. When VH and/or VL are/is expressed in host cells, a gene encoding any reporter molecule may also be cloned into the expression vector and VH and/or VL can be expressed as a fusion protein or a chimera protein with the reporter molecule.

In addition to the above methods, VH and/or VL can be obtained by proteolysis of the antibody molecule using a protease. This method has an advantage of saving time and effort on the gene cloning.

The VH-region polypeptide and the VL-region polypeptide may be a fusion product with a biomolecule. Such a fusion product has an advantage of improving the stability.

The biomolecule which can be fused with the VH-region polypeptide or the VL-region polypeptide is not particularly restricted, and examples thereof include alkaline phosphatase, protein G, eGFP, eYFP, β-galactosidase, GST, chitin binding protein (CBP), NusA, thioredoxin, DsbA, DsbC, and maltose binding protein (MBP). Among these, in order to further increase stability, MBP can be preferably used.

These fusion products can be produced by a conventional method. For example, the fusion product can be obtained by incorporating the gene encoding the biomolecule into a vector at the time of the above-described gene cloning so as to be expressed simultaneously, or by adding a linker to the VH-region polypeptide or the VL-region polypeptide to link with the biomolecule. The method for producing the fusion product can be appropriately selected depending on the type and size of the biomolecule to be fused.

An antibody fragment other than the VL-region polypeptide and the VH-region polypeptide can be produced in a manner similar to the method for producing the VL-region polypeptide and the VH-region polypeptide. Such a method is easily applicable by those skilled in the art.

The at least two types of antibody fragments immobilized on the substrate constitutes a set (combination) that is composed of at least one type of labeled antibody fragment and at least one type of acceptor antibody fragment and that is capable of recognizing one type of antigen. As long as the antibody fragments immobilized onto the substrate constitute such a set, the set may include not only two types but also three or more types of antibody fragments. When plural types of antibody fragments are used, the labeled antibody fragment(s) and acceptor antibody fragment(s) in one set can approach one another around one antigen. Consequently, the acceptor site of the acceptor antibody fragment can easily accept luminescence from the luminescent substance on the labeled antibody fragment. In consideration of emission accepting efficiency, it is preferable that labeled antibody fragments labeled with one type of luminescent substance and acceptor antibody fragments labeled with one type of emission-accepting substance are included in one set.

In the present invention, “the luminescent substance” broadly includes a substance capable of emitting light during a transition from an excited state caused by excitation light, oxidization reactions or the like, to a ground state. Further, “accept luminescence” used herein broadly includes the emitting of light or the occurrence of a chemical reaction caused directly or indirectly by excitation of the luminescent substance in an excited state. Both the labeled antibody fragment and the acceptor antibody fragment in the present invention may respectively be labeled with a luminescent substance, or only the labeled antibody may be labeled with a luminescent substance. When both of the labeled antibody fragment and acceptor antibody fragment are respectively labeled with a luminescent substance, each antibody fragment may be labeled with the luminescent substance at any site as long as binding of the antibody fragment with the antigen or the substrate is not inhibited. Examples of the label that can be introduced into the acceptor antibody fragment capable of accepting luminescence of the luminescent substance include luminescent substances, but are not particularly restricted as long as the label can be repeatedly used. For example, the ALPHASCREEN kit (trade name, manufactured by PerkinElmer Co., Ltd.), which generates singlet oxygen and emits light from a fluorescent substance, can be used for labeling.

A method for labeling the antibody fragment with a luminescent substance can be appropriately selected depending on the type of the luminescent substance. When the luminescent substance is a nonpeptidic compound, the labeling can be carried out by a known method including a method in which a thiol group or an amino group of the antibody is chemically modified with a functional group such as a maleimide group or a succinimide group. When the luminescent substance is a peptidic compound such as a fluorescent protein, the labeled antibody fragment can be produced as a fusion protein with antibody fragment. Any known method can be used for producing the fusion protein.

The antibody fragment of the invention may be labeled with a luminescent substance at any position as long as the acceptor antibody fragment can accept luminescence when the labeled antibody fragment and the acceptor antibody fragment are bound to the antigen by an antigen-antibody reaction. The luminescent substance may be linked directly to the antibody fragment or may be linked via a spacer. The position of the luminescent substance may be appropriately adjusted by using the spacer such that the luminescence can be accepted when the antibody fragment labeled with the luminescent substance and the acceptor antibody fragment are bound to the antigen by the antigen-antibody reaction. Examples of the spacer include flexible hydrophilic molecules such as polyethylene glycol derivatives and peptides. In consideration of emission accepting efficiency, polyethylene glycol is preferable.

In consideration of accuracy and ease of detection or the like, preferable examples of the luminescent substances used for labeling the labeled antibody fragment or the acceptor antibody fragment include a fluorescent donor substance and acceptor substance, in which a fluorescence resonance energy transfer (FRET) or a bioluminescence resonance energy transfer (BRET) occurs between the luminescent substance on the labeled antibody fragment and the luminescent substance on the acceptor antibody fragment. It is preferable that each of the labeled antibody fragment and the acceptor antibody fragment is labeled with a luminescent substance (that is, fluorescent substance) between which FRET can occur.

The fluorescence resonance energy transfer described above is well known, as described in paragraphs [0158] to [0161] of examined Japanese patent publication (JP-B) No. 2007-523754, and in paragraph [0025]ofJP-B No. 2001-519525. A variety of donors and acceptors used for fluorescence resonance energy transfer system are commercially available. Any combination of donors and acceptors can be used as long as the fluorescence resonance energy transfer occurs between the donor and acceptor, and can be appropriately selected based on the information in literature or from commercially available products. The donors and acceptors may be selected from the group consisting of fluorescent dyes and fluorescent proteins. Examples thereof include fluorescein derivatives, rhodamine derivatives, aminocoumarin derivatives, hydroxycoumarin derivatives, BODIPY derivatives, anthracene derivatives, benzofuran derivatives, porphyrin derivatives, CY dyes, ALEXA FLUOR dyes, europium cryptates, Dy light dyes, HILYTE FLUOR dyes, OYSTER dyes, MEGASTOKES dyes, IRDYEs, QSYs, DFPs, YFPs, GFPs and BFPs, and azamethine compounds such as those described in JP-A No. 2001-089482.

When the present invention utilizes a fluorescence resonance energy transfer technique, fluorescent substances used in the invention are preferably stable substances between which an energy transfer may occur. Preferable examples thereof include a combination of a fluorescent protein and a fluorescent dye, such as a combination of CFP and YFP, a combination of ALEXA FLUOR 555 and ALEXA FLUOR 647, a combination of FITC and ALEXA FLUOR 555, and a combination of HILYTE FLUOR 555 and ALEXA FLUOR 647. Examples of fluorescent substances further include, but are not limited to, a combination of fluorescent proteins, a combination of fluorescent dyes, and a combination of a fluorescent dye and a fluorescent protein. In consideration of stability of fluorescence emission, the fluorescent substances are preferably ALEXA FLUOR dyes or HILYTE FLUOR dyes, and more preferably ALEXA FLUOR dyes.

In addition, fluorescence resonance energy transfer between CFP and YFP, between GFP and BFP, and between modified products of these dyes are well known, and these fluorescent proteins are commercially available. When the fluorescent protein is used, a single fusion protein in which an antibody to be labeled is linked with the fluorescent protein can be obtained. When the antibody is used in living cells, it is preferable to use a fluorescent protein since a fusion protein of antibody with the fluorescent protein can be obtained by introducing a gene encoding the fusion protein into the cells. Nucleic acids encoding such fluorescent proteins are well known and a variety of vectors containing such fluorescent proteins are commercially available. Therefore, a fluorescent labeled protein in which a fluorescent protein is fused with a desired polypeptide can be easily obtained by using those commercially available vectors.

Examples of the biological-luminescent donor substance with which BRET can occur include a luciferin derived from luminous organisms, such as Photinus pyralis luciferin, Cypridina luciferin, Renilla reniformis luciferin, Diplocardia luciferin, Latia neritoides luciferin, Wataseniae luciferin or bacterial luciferins (for example, reduced flavin mononucleotide); and aequorin derived from Aequorea victoria. Examples of the acceptor substances include the same fluorescent proteins and fluorescent dyes as those of acceptor substances used in FRET described above.

Mechanisms for accepting and detecting emission by FRET or BRET are known in the art. For example, luminescence can be detected by using a method disclosed in BIOPHYSICS (Seibutsu Butsuri) Vol. 42(1), pp. 28-31 (2002). In this method, FRET or BRET can be confirmed by measuring and detecting luminescence obtained by irradiating light to a donor substance or inducing an enzyme reaction of a donor substance. In accordance with this method, antigen binding to antibodies immobilized on the immobilization substrate can be detected.

(3) A method for producing the antibody-fragment-immobilizing substrate

A method for producing an antibody-fragment-immobilizing substrate comprising:

contacting separate antibody fragments of at least two types that include at least one type of labeled antibody fragment having a labeled site labeled with a luminescent substance and at least one type of acceptor antibody fragment having an acceptor site for accepting emission from the labeled antibody fragment and that are capable of cooperatively recognizing one type of antigen, with the antigen, and forming a complex whereby each of the antibody fragments binds to the antigen;

immobilizing the complex on a substrate via the antibody fragments in the complex; and

removing the antigen from the complex to obtain the antibody-fragment-immobilizing substrate, wherein the antibody fragments are independently immobilized on the substrate in a positional relationship that allows each of the antibody fragments to bind to the same antigen.

According to the production method of the invention, since the complex composed of the antibody fragments of at least two types and the antigen is immobilized on the substrate, and then the antigen is removed from the complex, the antibody-fragment-immobilizing substrate, in which the antibody fragments are independently immobilized on the substrate in a positional relationship that allows each of the antibody fragments to bind to the same antigen in the presence of the antigen, can be easily produced.

According to the production method of the invention, an antibody-fragment-immobilizing substrate including a substrate and at least one set of (for example two or more sets of) antibody fragments may be obtained, in which the antibody fragments of each set include the at least two types of separate antibody fragments that have been immobilized on the substrate as described above.

When forming the complex, the complex composed of the antibody fragments and the antigen can be formed by a known technique. More specifically, the complex is easily obtained by mixing the above-described antibody fragments and antigen.

The mixing ratio of antibody fragments of at least two types to the antigen can be appropriately set depending on a binding mode of an antibody toward an antigen. In consideration of efficiency and in order to prevent excess immobilization of the antigens, the ratio of the number of antigens to the valencies of molecules formed by a combination of antibody fragments is from 0.1:1 to 10:1.

The mixing ratio of the antibody fragments and the antigen can be appropriately adjusted depending on affinity of the antibody fragments for an antigen, immobilization efficiency of the antigen per se to the substrate directly, or the like. In general, when the antigen is expected to have a sufficient affinity for the antibody fragments, the ratio of the number of antigens to the valencies of molecules formed by a combination of antibody fragments is from 0.1:1 to 1:1, and more preferably from 0.1:1 to 0.2:1. On the other hand, when the antigen is expected to have a low affinity or expected to be difficult to immobilize on the substrate directly, for example, when a low molecular compound or the like is used as the antigen, it is preferable to use an increased amount of the antigen. More specifically, the ratio of the number of antigens to the valencies of molecules formed by a combination of antibody fragments is preferably from 0.5:1 to 5:1.

Here, “the valencies of molecules formed by a combination of antibody fragments” means the number of the antigen-binding sites present in the molecules formed by a combination of antibody fragments. That is, when a molecule formed by a combination of antibody fragments constitutes a complete antibody molecule, the valencies of the molecules are equal to that of the antibody molecules. When a molecule formed by a combination of antibody fragments does not constitute a complete antibody molecule, the valency thereof is considered to be 1 as long as one antigen-binding site is included therein.

The antigen may be a low molecular weight molecule, or a high molecular weight molecule such as a protein. Although the complex may be formed by any number of molecules, in order to facilitate the control of the quantitative ratio, the number of molecules forming the complex is preferably three molecules such as two types of the antibody fragments and one antigen.

For example, when an anti-lysozyme VH-region polypeptide, an anti-lysozyme VL-region polypeptide and lysozyme (an antigen) are used, since the VH-region polypeptide and the VL-region polypeptide each interact with the antigen in a ratio of 1:1, a molecule formed by the combination of the VH-region polypeptide and the VL-region polypeptide has a valency of 1. Therefore, the complex can be readily obtained by mixing the VH-region polypeptide, VL-region polypeptide, and the antigen in an equal number ratio in an aqueous solution, that is, in a ratio of 1:1:1. In order to prevent decreasing of binding efficiency to the antibody fragments caused by the direct immobilization of lysozyme on the substrate, the number ratio of the antigen is preferably less compared with the valency of the antibody fragment. The mixing ratio among the VH-region polypeptide, VL-region polypeptide, and the antigen is preferably from 10:10:1 to 10:10:9, and more preferably from 10:10:1 to 10:10:2.

The ratio of the amount of the labeled antibody fragment to the acceptor antibody fragment can be appropriately adjusted depending on affinity of the antibody fragments for an antigen. In general, the ratio of the amount of the labeled antibody fragment to the acceptor antibody fragment is 1:1 in order to form an antibody molecule having a valency of 1. In consideration of immobilization efficiency of antigen fragments after labeling, the ratio of the labeled antibody fragment labeled with a donor substance to the acceptor antibody fragment labeled with an acceptor substance is preferably from 15:1 to 1:15, more preferably from 10:1 to 1:10, and still more preferably from 5:1 to 1:5.

When immobilizing the complex, the complex formed by the procedure described above is linked to the substrate by conducting the reaction appropriately in accordance with the type of functional group provided to the substrate. In this case, since the antigen-recognition site of the antibody fragment is protected by binding of the antigen, no additional protective treatment is required. Methods for linking the complex to the substrate are well known by those skilled in the art. Examples thereof include a method of activating a carboxyl group using EDC described above or the like and linking to a complex via an amino group, or a method in which a complex is linked to the substrate by a reaction of a maleimide group with a thiol group, but the present invention is not restricted thereto.

When the immobilization substrate according to the present invention is used for a biosensor, the antibody fragment may be immobilized on the substrate in an amount (density) such that there is a sufficient distance between the labeled antibody fragment and the acceptor antibody fragment, for example, about 10 nm or less, in order for the acceptor antibody fragment to accept the luminescence. The immobilizing amount of the antibody fragment is preferably from 1×10⁵/mm³ to 1×10¹⁸/mm³, more preferably from 1×10⁹/mm³ to 1×10¹⁵/mm³, and still more preferably from 1×10¹⁰/mm³ to 1×10¹⁴/mm³. When the immobilizing amount is 1×10⁵/mm³ or more, the luminescence can be easily measured. When the immobilizing amount is 1×10¹⁸/mm³ or less, an appropriate distance between fluorescent substances can be kept and a good S/N ratio can be obtained in FRET. An immobilizing amount within the above range is also preferable from the viewpoint of the production cost.

The density can be determined by the following method. When the density is determined by actual measurement, each antibody fragment is immobilized on the substrate, and then a test substance is washed away. The density is calculated based on the labeling amount of the labeled antibody fragment and the emission accepting amount of the acceptor antibody fragment, and a film thickness measured by using an AFM or an ellipsometry technique. When the luminescent substance on the labeled antibody fragment and the emission-accepting substance on the acceptor antibody fragment are both fluorescence molecules, the fluorescence amount of each substance is measured by a fluorescence meter, and the number of immobilized molecules is determined based on a labeling ratio of fluorescence molecules obtained before immobilization, and the volume of the immobilized molecules is measured, thereby calculating the immobilization density.

When removing the antigen from the complex, the complex is immobilized on the substrate and then the antigen is removed from the complex. Since each of the antibody fragments is independently immobilized on the substrate, the antigen can be readily removed. Therefore, when the substrate is used as the immobilization substrate, binding reproducibility of the antigen may not decrease.

The removal of the antigen is readily carried out by using an appropriate washing solution. Any solution can be used as the washing solution as long as the avidity of the antigen and the antibodies in the complex is reduced. Examples of a condition for reducing the avidity include altering a pH toward an acidic side or an alkali side, and/or increasing a salt concentration. The washing solution varies depending on the type of the antibody fragment and antigen or the like, and examples thereof include an acidic glycine buffer with which the pH may be adjusted to 2 or less; an alkaline NaOH solution with which the pH may be adjusted to 10 or more; and a borate buffer with which the salt concentration may be adjusted to 0.5 M or more.

In addition, an acidic buffer containing arginine, a buffer containing guanidine or a buffer containing urea can be appropriately used.

Here, the condition of the washing treatment with the washing solution can be appropriately controlled. In order not to impair the activity of the antibody fragment, the time for the washing treatment is in general 10 minutes or less, and preferably 1 minute or less. From the viewpoint of reproducibility, the time for the washing treatment is preferably 5 seconds or more.

Accordingly, the immobilization substrate on which the antibody fragments are independently immobilized in a positional relationship that allows each of the antibody fragments in one set to bind to the same antigen can be obtained. In the immobilization substrate of the invention, the antibody fragments independently immobilized on the substrate have a degree of freedom and can bind to the antigen. That is, the labeled antibody fragment and acceptor antibody fragment in one set are independently immobilized on the substrate in a positional relationship similar that when they are bound to the antigen. The antibody may be bound to the substrate via a part of the antibody, and a portion of the antibody having the antigen recognition site may be allowed to freely move. As long as the antibody fragments in one set can bind to one antigen, the antibody fragments after immobilization may freely move according to a position on the substrate where each antibody fragment binds (binding point) or the type of the substrate having the binding point (for example, the type of hydrophilic polymer).

Accordingly, when the antigen approaches the antibody fragments and may be bound, the antibody fragments may approach one another to bind to the antigen. In the present invention, the immobilization substrate for repeated use in which the antigen concentration can be determined rapidly by measuring an interaction between the luminescent substance and the accepting substance that accepts the luminescence, which are labeled with the respective antibody fragments, can be easily obtained.

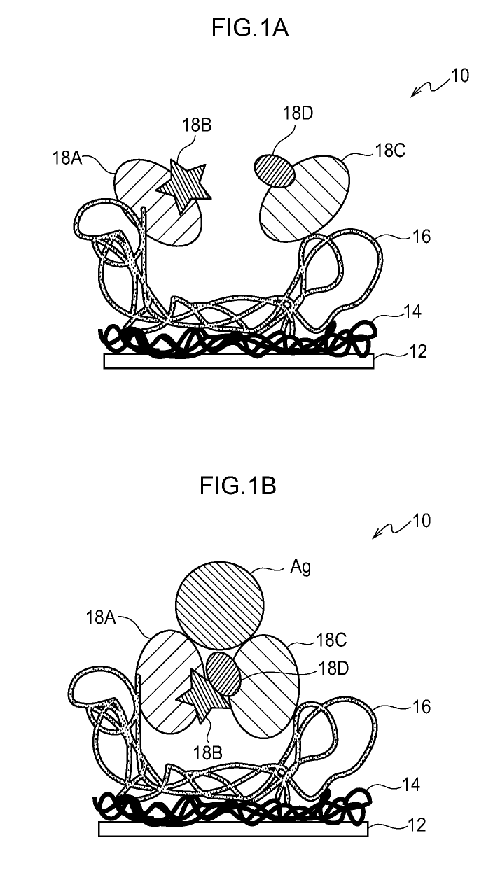

For example, FIGS. 1A and 1B show an immobilization substrate 10, which is an example of the antibody-fragment-immobilizing substrate according to the present invention. In the immobilization substrate 10, antibody fragments 18A and 18C are independently immobilized on a substrate 12 via a self-assembled monolayer 14 and a polymer layer 16 through a part of each antibody. The antibody fragment 18A has a site labeled with a luminescent substance 18B, and the antibody fragment 18C has a luminescence accepting site 18D. The antibody fragment 18A and the antibody fragment 18C are bound to the substrate 12 through one end of each antibody fragment such that the other end of each antibody fragment can move freely, and are independently immobilized on the substrate 12 in a positional relationship that allows the antibodies to cooperatively bind to an antigen Ag if present (see FIG. 1A).

When the antigen Ag approaches the immobilization substrate 10, the antibody fragments 18A and 18B recognize and bind to the antigen Ag. When binding, the antibody fragments 18A and 18C approach each other centering around the antigen and bind to the antigen, whereby the luminescent substance 18B on the antibody fragment 18A and the luminescence accepting site 18D on the antibody fragment 18C approach and interact. By measuring the change caused by this interaction, the antigen can be detected (see FIG. 1B).

As described above, by immobilizing the complex formed by two or more antibody fragments and one or more antigens on the substrate through the two or more antibody fragments and then removing only the antigens, the antibody-fragment-immobilizing substrate which can be utilized in an immunoassay using an antigen-antibody reaction can be obtained.

Since the antibody fragments are independently immobilized on the substrate as described above, when the affinity between them is low, the antibody fragments do not associate with one another and can easily move independently of one another, whereby the conformational change of the antibody fragment more easily occurs when the antigen binds. This conformational change increases the efficiency of the fluorescent energy transfer. Regarding the affinity between the antibody fragments, the dissociation constant (Kd) is preferably from 10⁻¹² to 10⁸, more preferably from 10⁻⁷ to 10⁸, and still more preferably form 10⁻⁵ to 10⁻¹.

(II) Application of the Immobilization Substrate According to the Present Invention

The immobilization substrate according to the present invention can be applied to a biosensor or a bioreactor based on a binding reactivity between the antibody fragments and the antigen (for example, see “Bioreactor Technique”, 1988, CMC Publishing Co., Ltd., and “Biochip and Biosensor”, 2006, Kyoritsu Shuppan Co., Ltd.). Here, the bioreactor refers to a reactor applied for production of useful materials, generation of energy, degradation of environmental pollutants or the like by utilizing a biochemical reaction by biological catalysts such as enzymes, bacteria cells, cells, or organelles. Here, the term biosensor is intended to be interpreted most broadly, and means a sensor that measures and/or detects a target substance by converting an interaction between biological molecules into a signal such as an electrical signal. Hereinafter, the application to the bioreactor and the biosensor will be described.

(1) Application to the Bioreactor

A bioreactor capable of carrying out generation of useful substances, reaction, or the like using an insoluble substrate immobilizing an enzyme is described (for example, Examined utility model application publication (JP-Y) Nos. 4-18398 and 4-18399). The substrate according to the present invention, for example, in the form of a substrate having a support (for example, a porous material such as ceramic or polysulfone), a polymer membrane bound to this substrate surface, and an enzyme and an auxiliary substance for an enzyme activity which are bound to this polymer membrane can be applied, as such insoluble substrate, to the bioreactor.

(2) Application to a Biosensor

In general, a biosensor is composed of a receptor portion recognizing target chemicals to be detected and a transducer portion converting a physical change or a chemical charge generated at the receptor portion into an electric signal. Examples of a combination of substances having a mutual affinity in a living body include a combination of enzyme and substrate, a combination of enzyme and coenzyme, a combination of antigen and antibody, and a combination of hormone and receptor. The biosensor employs a principle that, by immobilizing one of the substances with mutual affinities of such a combination on a substrate and using it as a molecule-recognizing substance, the corresponding other substance is selectively measured. The substrate according to the present invention can be applied to be, for example, a substrate having a support (for example, a porous material such as ceramic or polysulfone), a polymer membrane bound to this substrate surface, and two types of antibody fragments which are bound to this polymer membrane, in order to achieve more rapid detection compared with conventional biosensor and to obtain a biosensor that can be repeatedly used and have a greater versatility.

Hereinafter, the immobilization substrate of the invention will be described in more detail with reference to examples, but the invention is not limited to the examples. Further, “parts” and “%” indicate quantities in terms of mass, unless otherwise specified.

### EXAMPLES

### Example 1

(1) Preparation of Anti-Lysozyme VH-Region Polypeptide and Anti-Lysozyme VL-Region Polypeptide

Abbreviations used in the Examples are as follow:
LB: culture medium containing 1% BACTO (Registered tradename) Tryptone, 0.5%
Yeast Extract and 0.5% NaCl
LBA: LB containing 100 m/ml of ampicillin
LBAG: LB containing 100 μg/ml of ampicillin and 0.1% glucose
LBAG plate: LB agar medium containing 100 μg/ml of ampicillin and 0.1% glucose
SOC: culture medium containing 2% BACTO (Registered tradename) Tryptone, 0.5% Yeast Extract, 0.05% NaCl, 2.5 mM KCl, 20 mM glucose and 10 mM MgCl₂
PBS: 10 mM phosphate buffer (pH 7.2) containing 137 mM NaCI and 2.7 mM KCl
5% IBPBS: PBS containing 5% (v/v) of IMMONOBLOCK (trade name, manufactured by Dainippon Sumitomo Pharma Co., Ltd., Osaka)
20% IBPBS: PBS containing 20% (v/v) IMMONOBLOCK
PBST: PBS containing 0.1% of Triton-X 100
TAE buffer: 40 mM Tris-acetate buffer (pH 8.3) containing 1 mM EDTA
TALON buffer: 50 mM sodium phosphate buffer (pH 7.0) containing 300 mM NaCl
TALON elution buffer: TALON buffer (pH 7.0) containing 500 mM imidazole
IPTG: isopropyl-β-thiogalactopyranoside
HBS-N buffer: 10 mM HEPES, 150 mM NaCl, pH 7.4

In all experiments, water purified with MILLI-Q (trade name, manufactured by Millipore Co., Billerica, Mass., USA) was used. Hereinafter, this purified water is referred to as milliQ water. Unless otherwise specified, general reagents used were obtained from Sigma-Aldrich Co. (St. Louis, Mo., USA), Nacalai Tesque (Kyoto, Japan), Wako Pure Chemical Industries, Ltd. (Osaka, Japan), or Kanto Chemical Co. Inc. (Tokyo, Japan). Oligo DNAs were synthesized by Texas Genomics Japan (Tokyo, Japan) or Invitrogen (Tokyo, Japan).

The genotypes of E. coli XL10-Gold and OverExpress C41 are shown in Table 1, and the primer sequences used for PCR are shown in Table 2.

TABLE 1
<E. coli.>

XL10-Gold:
Tetr Δ(mcrA)183 Δ(mcrCB-hsdSMR-mrr) 173 endA1 supE44 thi-1 recA1
gyrA96 relA1 lac Hte [F′proAB lacIqZΔM15 Tn10 (Tet^{r}) Amy Cam^{r}]
OverExpress C41(DE3):
F⁻, ompT, hsdS_{B}(r_{B}⁻ m_{B}⁻), gal(λcI 857, ind1, Sam7, nin5,
lacUV5-T7gene1), dcm(DE3)

TABLE 2
<Primer>

(1)
SEQ ID NO: 1
AAAAAAAGCGGCCGCGGAGCATCATCACCATCACCACCACCACCACCACT
GAGATCCGG
(The underline indicates the NotI site and the
double-underline indicates the His10 sequence.)
(2)
SEQ ID NO: 2
CCAATGCTTAATCAGTGA
(3)
SEQ ID NO: 3
CTTTCTATGCGGCCCAGCCGGCCATGGCCGAKGTSVAGCTTCAGGAGTC
(The underline indicates the SfiI site.)
(4)
SEQ ID NO: 4
AAAAAAGCGGCCGCGCTCGAGACGGTGACCGTGG
(The underline indicates the NotI site.)
(5)
SEQ ID NO: 5
AAAAAAGGCCCAGCCGGCCATGGCGTCGACGGATATTTTGATGAC
(The underline indicates the SfiI site.)
(6)
SEQ ID NO: 6
TTTCTCGTGCGGCCGCACGTTTTATTTCCAACTTTG
(The underline indicates the NotI site.)

(A) Construction of Expression Plasmids

(a) Vectors Used in the Experiments
pET-MBPp-His6: pET15b vector (Merck Chemicals Ltd., Darmstadt, Germany), into which the gene encoding maltose binding protein (MBP) tagged with His-Tag containing six histidine residues (His6) is inserted (SEQ ID NO: 7).
pIT2-LxE16: pIT2 vector (provided by MRC Cambridge, UK), into which the single-chain antibody (scFv) gene encoding anti-hen egg lysozyme (HEL) antibody LxE16 (SEQ ID NO: 8, amino acid: SEQ ID NO: 9) (isolated at Laboratory of Protein Engineering, Department of Chemistry and Biotechnology, Graduate School of Engineering, University of Tokyo) is inserted.

(b) Outline of the Preparation of the Expression Vectors

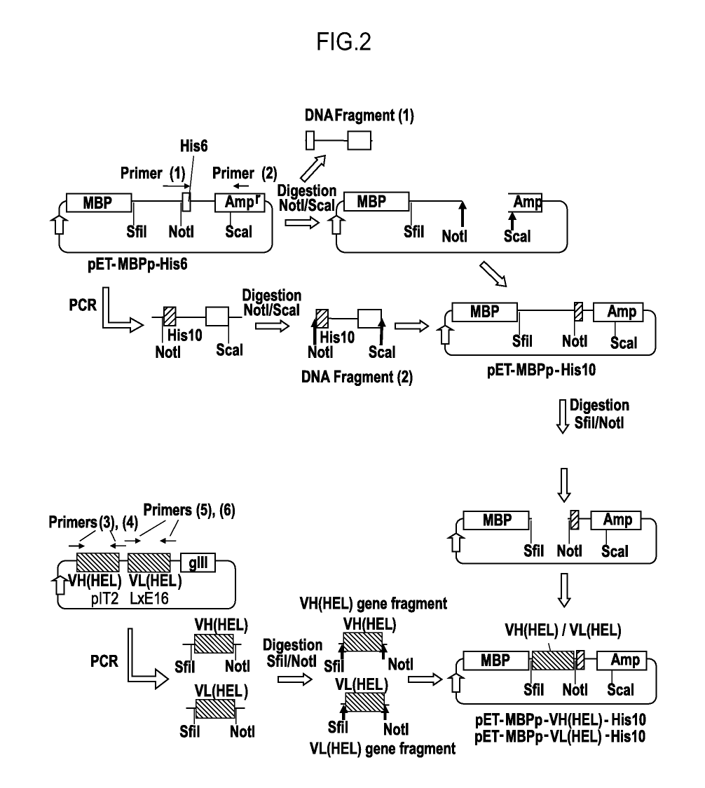

As shown in the scheme of FIG. 2, each of an expression vector pET-MBPp-VH(HEL)-His10 encoding a MBP-VH(HEL)-His10 protein, in which MBP and a His-tag containing ten histidine residues (His10) are respectively fused to N- and C-terminals of VH(HEL) (the heavy-chain variable region domain of the anti-lysozyme antibody LxE16), and an expression vector pET-MBPp-VL(HEL)-His10 encoding a MBP-VL(HEL)-His10 protein, in which MBP and His10 are respectively fused to N- and C-terminals of VL(HEL) (the light-chain variable region domain of the anti-lysozyme antibody LxE16) was constructed by using the pET-MBPp-His6.

First, DNA fragment (1) containing His6 was isolated from the pET-MBPp-His6, and then DNA fragment (2) encoding His10 was inserted thereinto, thereby obtaining a pET-MBPp-His10. Subsequently, a VH(HEL) gene (SEQ ID NO: 10, Table 3) was inserted into the pET-MBPp-His10, thereby obtaining the pET-MBPp-VH(HEL)-His10. Separately, a VL(HEL) gene (SEQ ID NO: 11, Table 4) was inserted into the pET-MBPp-His10, thereby obtaining the pET-MBPp-VL(HEL)-His10.

TABLE 3
VH(HEL)
ATGGCCGAGGTGCAGCTTCAGGAGTCAGGACCTAGCCTCGTGAAACCTTC
TCAGACTCTGTCCCTCACCTGTTCTGTCACTGGCGACTCCATCACCAGGG
GTTACTGGAGCTGGATCCGGAAATCCCCAGGAAATAAACTTGAGTACATG
GGGTACATAAGCTACAGTGGTAGCACTTTCTACAATCCATCTCTCAAAAG
TCGAATCTCCATCACTCGAGACACATTCAAGAACCAGCTCTACCTGCAGT
TGAATTCTGTGACTACTGAGGACACAGCCACATATTATTGTGCAGAGTAC
GACGGGACTTACTGGGGCCAAGGGACCACGGTCACCGTCTC

TABLE 4
VL(HEL)

TCGACGGATATTTTGATGACCCAGACTCCAGCCACCCTGTCTGTGACTCC
AGGAGATAGCGTCAGTCTTTCCTGCAGGGCCAGCCAAAGTATTGGCAACA
ACCTACACTGGTTTCAACAAAAATCACATGAGTCTCCAAGGCTTCTCATC
AAGTATGCTTCCCAGTCCATCTCTGGGATCCCCTCCAGGTTCAGTGGCAG
TGGATCAGGGACAGATTTCACTCTCAGTATCAACACTGTGGAGACTGAAG
ATTTTGGAATGTATTTCTGTCAACAGAGTAACAGCTGGCCGTACACGTTC
GGAGGGGGGACAAAGTTGGAAATAAAACGT

(b) Isolation of DNA Fragment (1) from the pET-MBPp-His6

To 74 μl of an aqueous solution containing about 10 μg of pET-MBPp-His6, 3 μl of ScaI (Roche Applied Science, Basel, Switzerland, 10 U), 3 μl of NotI (Roche Applied Science, 10 U), 10 μl of 10× BSA solution and 10 [LI of 10×H buffer (Roche Applied Science) were added, and the mixture was then left to stand for about 3 hours at 37° C. Subsequently, the mixture was subjected to electrophoresis on 1% agarose gel (in TAE buffer), and then a DNA band of approximately 4,100 by was excised and extracted using WIZARD SV Gel And PCR Clean-Up System (trade name, manufactured by Promega Co., Madison, Wis.). The extracted DNA was dissolved in 50 μl of milliQ water.

(c) Preparation of DNA Fragment (2)

PCR was performed by using the pET-MBPp-His6 as the template, a primer (1) (SEQ ID NO: 1) and a primer (2) (SEQ ID NO: 2). The primer (1) is a reverse primer having a nucleic acid sequence corresponding to ten histidine residues and having the NotI site; and an annealing site of the primer (1) is located downstream of the His6 coding region. The primer (2) is a forward primer; and an annealing site of the primer (2) is located approximately 500 bases downstream of the ScaI site of the pET vector.

The PCR conditions are as follows:

Composition of the Reaction Mixture

| | |
|---|---|
| pET-MBPp-His6 (about 100 μg/ml) | 0.5 μl |
| Primer (1) (50 μM) | 0.5 μl |
| Primer (2) (50 μM) | 0.5 μl |
| 10 × Pfu buffer (20 mM Mg²⁺) | 5 μl |
| (Agilent Technologies, Inc., Santa Clara, CA) | |
| dNTP Mixture (2.5 mM each) | 4 μl |
| 2.5 U/μl of Pfu DNA polymerase | 0.5 μl |
| (Agilent Technologies, Inc.) | |
| milliQ water | 39 μl |

Reaction Cycle

1.94° C., 1 min

2. 94° C., 30 sec

3. 58° C., 30 sec

4. 72° C., 30 sec

(25 cycles of steps 2 to 4)

5. 72° C., 10 min

6. 16° C.∞

The PCR product was purified with WIZARD SV Gel And PCR Clean-Up System (Promega Co., Madison, Wis.) and dissolved in 50 μl of milliQ water. To the solution, 1 μl of ScaI (Roche Applied Science, 10 U), 1 μl of NotI (Roche Applied Science, 10 U), 7 μl of 10× BSA solution, 7 μl of 10×H buffer (Roche Applied Science) and 4 μl of milliQ water were added, and the mixture was then left to stand for about 3 hours at 37° C. Subsequently, the mixture was subjected to electrophoresis on 1% agarose gel (in TAE buffer), and then a DNA band of approximately 1,080 by was excised and extracted using WIZARD SV Gel And PCR Clean-Up System. The extracted DNA was dissolved in 50 μl of milliQ water, thereby obtaining a solution of DNA fragment (2).

(d) Preparation of pET-MBPp-His10

0.5 ml of a solution containing the pET-MBPp-His6 from which DNA fragment (1) has been removed was mixed with 5 μl of the solution of DNA fragment (2). Subsequently, 5.5 μl of DNA LIGATION HIGH Ver2 Solution (trade name, manufactured by TOYOBO Co., Ltd., Osaka, Japan) was added to the mixture, and then DNA ligation was performed for 30 minutes at 16° C. Thereafter, about 50 μl of E. coli XL10-Gold chemical competent cells were transformed with about 1 ml of the ligation reaction mixture. The transformants were cultured on LBAG agar medium overnight at 37° C. A single-colony transformant was further cultured in 50 ml of LBAG overnight, and then the plasmid DNA was extracted using WIZARD PLUS MINIPREPS DNA Purification Kit (trade name, manufactured by Promega Co.), thereby obtaining a pET-MBPp-His10. The DNA sequence encoding His10 was confirmed in accordance with a protocol from Beckman Coulter, Inc.

(e) Restriction Enzyme Treatment of pET-MBPp-His10

To 46 μl of an aqueous solution containing about 7 μg of pET-MBPp-His10, 2 μl of SfiI (Roche Applied Science, 10 U), 6 μl of 10× BSA solution and 6 μl 10×M buffer (Roche Applied Science) were added, and the mixture was then left to stand for about 3 hours at 50° C. DNA was purified using WIZARD SV Gel And PCR Clean-Up System and then dissolved in 50 μl of an aqueous solution. To the DNA solution, 2 μl of NotI (Roche Applied Science, 10 U), 7 μl of 10× BSA solution, 7 μl of 10×H buffer (Roche Applied Science) and 4 μl of milliQ water were added, and the mixture was then left to for about 3 hours stand at 37° C. Subsequently, the mixture was subjected to electrophoresis on 1% agarose gel (in TAE buffer), and then a DNA band of approximately 4,800 by was excised and extracted using WIZARD SV Gel And PCR Clean-Up System. The extracted DNA was dissolved in 50 μl of milliQ water.

(f) Preparation of VH(HEL) Gene Fragment

PCR amplification of the VH(HEL) gene fragment was performed by using pIT2-LxE16 as a template, and a primer (3) and a primer (4). The primer (3) is a reverse primer having a SfiI site; and an annealing site of the primer (3) is located at the 5′ side of the VH(HEL) gene fragment. The primer (4) is a forward primer having the NotI site; and an annealing site of the primer (4) is located at the 3′ side of the VH(HEL) gene fragment.

The PCR conditions are as follows:

Reaction Mixture Composition

| | |
|---|---|
| pIT2-LxE16 (about 100 μg/ml) | 0.5 μl |
| Primer (3) (50 μM) | 0.5 μl |
| Primer (4) (50 μM) | 0.5 μl |
| 10 × Pfu buffer (20 mM Mg²⁺) (Agilent Technologies, Inc.) | 5 μl |
| dNTP Mixture (2.5 mM each) | 4 μl |
| 2.5 U/μl of Pfu DNA polymerase (Agilent Technologies, Inc.) | 0.5 μl |
| milliQ water | 39 μl |

Reaction Cycle

1.94° C., 1 min

2. 94° C., 30 sec

3. 58° C., 30 sec

4. 72° C., 30 sec

(25 cycles of steps 2 to 4)

5. 72° C., 10 min

6. 16° C.∞

The PCR product was purified with WIZARD SV Gel And PCR Clean-Up System and dissolved in 50 μl of milliQ water. To the solution, 2 μl of Sid (Roche Applied Science, 10 U/μl), 7 μl of 10× BSA solution, 7 μl of 10×M buffer (Roche Applied Science) and 4 μl of milliQ water were added, and the mixture was then left to stand for about 3 hours at 50° C. The resulting DNA was purified with WIZARD SV Gel And PCR Clean-Up System and dissolved in 50 μl of aqueous solution. To the DNA solution, 2 μl of NotI (Roche Applied Science, 10 U), 7 μl of 10× BSA solution, 7 μl of 10×H buffer (Roche Applied Science) and 4 μl of milliQ water were added, and the mixture was then left to stand for about 3 hours at 37° C. Subsequently, the resulting DNA was purified with WIZARD SV Gel And PCR Clean-Up System. The extracted DNA was dissolved in 50 μl of milliQ water, thereby obtaining a solution of the VH(LxE16) gene fragment.

(g) Preparation of VL(HEL) Gene Fragment

PCR amplification of the VL(HEL) gene fragment was performed by using pIT2-LxE16 as a template, and a primer (5) and a primer (6). The primer (5) is a reverse primer having a SfiI site; and an annealing site of the primer (5) is located at the 5′ side of the VL(HEL) gene fragment. The primer (6) is a forward primer having a NotI site; and an annealing site of the primer (6) is located at the 3′ side of the VL(HEL) gene fragment. PCR, restriction enzyme treatment and purification of DNA were performed in the same manner as in preparation of VH(LxE16) gene fragment, thereby obtaining a solution of the VL(LxE16) gene fragment.

(h) Preparation of pET-MBPp-VH(HEL)-HislO and pET-MBPp-VL(HEL)-His10

0.5 μl of a solution containing the restriction enzyme treated pET-MBPp-His10 was mixed with 5 μl of the solution of VH(LxE16) or VL(LxE16). Subsequently, 5.5 μl of DNA LIGATION HIGH Vert Solution (TOYOBO Co., Ltd.) was added to the mixture, and then DNA ligation was performed for 30 minutes at 16° C. Thereafter, about 50 μl of E. coli XL10-Gold chemical competent cells were transformed with about 1 μl of the ligation reaction mixture. The transformants were cultured on LBAG agar medium overnight at 37° C. Single colony transformants were further cultured in 50 ml of LBAG overnight, and then the plasmid DNA was extracted using WIZARD PLUS MINIPREPS DNA. Purification Kit (Promega Co.). The DNA sequences of pET-MBPp-VH(HEL)-His10 and pET-MBPp-VL(HEL)-His10 were confirmed in accordance with a protocol from Beckman Coulter, Inc.

(B) Preparation of MBP-VH(HEL)-His10 Protein and MBP-VL(HEL)-His10 Protein

The pET-MBPp-VH(HEL)-His10 and pET-MBPp-VL(HEL)-His10 plasmids were respectively transformed into E. coli OverExpress C41(DE3) by the heat shock method to express the genes. 1 μl of the plasmid (about 100 ng) and 100 μl of OverExpress C41(DE3) competent cells were mixed, and the mixture was then left to stand for 30 min on ice. Subsequently, heat shock was performed for 45 seconds at 42° C. Immediately after the heat shock, the mixture was left to stand for 2 minutes on ice. Thereafter, the cells were cured for 30 minutes by adding 200 μl of SOC medium thereto. The mixture was then spread on LBA plate and incubated overnight at 37° C.

A grown colony was inoculated into 4 ml of LBAG and cultured overnight at 30° C. with shaking. 4 ml of the small-scale culture was then added to 800 ml of LBA, and cultured at large scale at 30° C. with shaking. When an O.D.600 of the culture reached between 0.5 and 0.6, 400 μl of 1000 mM IPTG was added thereto and further cultured overnight at 30° C. with shaking. The bacterial culture was then separated into supernatants and pellets of E. coli by centrifugation. By the methods described below, the MBP-VH(HEL)-His10 protein (SEQ ID NO: 12, Table 5) was independently collected from the supernatants by ammonium sulfate precipitation and from the pellet by ultrasonication of bacterial cells. Further, by the methods described below, the MBP-VL(HEL)-His10 protein (SEQ ID NO: 13, Table 6) was independently collected from the supernatants by ammonium sulfate precipitation and from the pellet by ultrasonication of bacterial cells.

TABLE 5
MBP-VH HEL)-His10

MKIKTGARILALSALTTMMFSASALAKIEEGKLVIWINGDKGYNGLAEVG
KKFEKDTGIKVTVEHPDKLEEKFPQVAATGDGPDIIFWAHDRFGGYAQSG
LLAEITPDKAFQDKLYPFTWDAVRYNGKLIAYPIAVEALSLIYNKDLLPN
PPKTWEEIPALDKELKAKGKSALMFNLQEPYFTWPLIAADGGYAFKYENG
KYDIKDVGVDNAGAKAGLTFLVDLIKNKHMNADTDYSIAEAAFNKGETAM
TINGPWAWSNIDTSKVNYGVTVLPTFKGQPSKPFVGVLSAGINAASPNKE
LAKEFLENYLLTDEGLEAVNKDKPLGAVALKSYEEELAKDPRIAATMENA
QKGEIMPNIPQMSAFWYAVRTAVINAASGRQTVDEALKDAQTNSSSNNNN
NNNNNNLGPGAAHY--
VEFAAQPAMADVELQESGPSLVKPSQTLSLTCSVTGDSITRGYWSWIRKF
PGNKLEYMGYISYSGSTFYNPSLKSRISITRDTFKNQLYLQLNSVTTEDT
ATYYCAEYDGTYWGQGTTVTVSSAAAEHHHHHHHHHH
-: Protease cleavage site

TABLE 6
MBP-VL(HEL)-His10

MKIKTGARILALSALTTMMFSASALAKIEEGKLVIWINGDKGYNGLAEVG
KKFEKDTGIKVTVEHPDKLEEKFPQVAATGDGPDIIFWAHDRFGGYAQSG
LLAEITPDKAFQDKLYPFTWDAVRYNGKLIAYPIAVEALSLIYNKDLLPN
PPKTWEEIPALDKELKAKGKSALMFNLQEPYFTWPLIAADGGYAFKYENG
KYDIKDVGVDNAGAKAGLTFLVDLIKNKHMNADTDYSIAEAAFNKGETAM
TINGPWAWSNIDTSKVNYGVTVLPTFKGQPSKPFVGVLSAGINAASPNKE
LAKEFLENYLLTDEGLEAVNKDKPLGAVALKSYEEELAKDPRIAATMENA
QKGEIMPNIPQMSAFWYAVRTAVINAASGRQTVDEALKDAQTNSSSNNNN
NNNNNNLGPGAAHY--
VEFAAQPAMASTDILMTQTPATLSVTPGDSVSLSCRASQSIGNNLHWFQQ
KSHESPRLLIKYASQSISGIPSRFSGSGSGTDFTLSINTVETEDFGMYFC
QQSNSWPYTFGGGTKLEIKRAAAEHHHHHHHHHH
-: Protease cleavage site

In the case of using the supernatant, 344 g of ammonium sulfate was added to about 800 ml of the culture supernatant and the mixture was stirred overnight at 4° C. Subsequently, an insoluble matter containing MBP-VH(HEL)-His10 or MBP-VL(HEL)-His10 was collected by centrifugation and the pellet was suspended in 30 ml of TALON buffer. In the case of using the pellet of E. coli, the pellet was suspended in 30 ml of TALON buffer and then subjected to ultrasonication, followed by centrifugation, to collect a supernatant containing MBP-VH(HEL)-His10 or MBP-VL(HEL)-His10. The supernatant was dialyzed against the TALON buffer. Each protein collected in TALON buffer was applied to a column (16 mm-diameter×about 15 mm-height) filled with a TALON affinity resin (trade name, manufactured by Clontech Laboratories, Inc., Mountain View, Calif.). Subsequently, TALON affinity resin, onto which the protein was adsorbed, was washed with the TALON buffer, and then a TALON elution buffer was added to elute MBP-VH(HEL)-His10 or MBP-VL(HEL)-His10. The purified protein was confirmed by SDS-PAGE. The buffer of the eluate was changed to HBS-N, and then glycerol was added thereto at a final concentration of 16%. The obtained solution was stored at −80° C.

(C) Preparation of VL(HEL)-His10

To 1 ml of the purified MBP-VL(HEL)-His10 solution (in HBS-N, about 1000 μg/ml), 20 μl of GENENASE solution (New England Biolabs, Inc., Ipswich, Mass.) was added. The mixture was allowed to react at room temperature for about 5 hours. After the reaction, in the same manner as described above, VL(HEL)-His10 was purified using the TALON affinity resin and the buffer of the eluate was changed to HBS-N.

(D) Preparation of MBP-VH(HEL)-His10 Labeled with ALEXA FLUOR 555

440 μl of a solution containing the MBP-VH(HEL)-His10 obtained above (in HBS-N, about 430 μg/ml) was labeled with ALEXA FLUOR (registered trademark) 555 (manufactured by Molecular Probes). The labeling reaction was performed at pH 7.0.

(E) Preparation of VL(HEL)-His10 Labeled with ALEXA FLUOR 647

27 μl of a solution containing the VL(HEL)-His10 obtained above (in HBS-N, about 1,679 μg/ml) was labeled with ALEXA FLUOR (registered trademark) 647 (manufactured by Molecular Probes). The labeling was performed at pH 7.0.

(2) Fabrication of a Substrate Provided with a Carboxyl Group

(A) Washing the Substrate

A glass slide (manufactured by Matsunami Glass Ind., Ltd) was irradiated with UV, and immersed in acetone and ultrasonicated for 5 minutes. Subsequently, the glass slide was removed from acetone and washed with purified water.

(B) Providing an Amino (APS) Group

72 ml of ethanol and 8 ml of purified water were mixed in a 100 ml glass vial. The mixed solution was heated for about 15 minutes at 60° C. in an incubator (manufactured by AS ONE Corporation). To the heated mixed solution of ethanol and purified water, 80 μl of APS (γ-aminopropyltriethoxysilane) (manufactured by Tokyo Chemical Industry Co., Ltd.) (0.1% v/v) was added and dissolved. Subsequently, the washed glass slide was immersed in this solution and allowed to react in the incubator (manufactured by AS ONE Corporation) for 15 minutes at 60° C., thereby obtaining a glass slide provided with the amino group. After the reaction, the glass slide was removed from the solution, and then washed by immersing the glass slide into a solution of ethanol and water at a ratio of 9:1 and then removing it. The washing was repeated three times. The glass slide after the washing was dried by blowing nitrogen gas thereon and baked for 1 hour at 120° C. After the baking, the glass slide was washed by sequentially immersing it in ethanol and purified water.

(C) Active Esterification of CMD

To a 0.5% by mass solution of CMD (carboxymethyl dextran, manufactured by Meito Sangyo Co., Ltd., molecular weight 1,000,000) dissolved in ultrapure water, a mixed solution containing 0.4 M EDC (1-(3-Dimethylaminopropyl)-3-ethylcarbodiimide) and 0.1 M NHS (N-Hydroxysuccinimide) was added, being an amount calculated such that 2% of the carboxyl group in CMD is activated when the entire amount was reacted, and stirred for 5 minutes at room temperature.

(D) Preparation of a CMD Film

The active esterified CMD solution was dropped onto the above prepared glass substrate having the amino group thereon. After 30 seconds, the solution was removed, whereby a thin film of active esterified carboxy methyl dextran was formed on the substrate having the amino group. The substrate was reacted for 1 hour at room temperature, and then washed once with 0.1 N NaOH and once with ultrapure water.

(3) Formation of a Complex

MBP-VH(HEL)-His10 labeled with ALEXA FLUOR 555 and VL(HEL)-His10 labeled with ALEXA FLUOR 647, both of which were prepared above, and lysozyme were mixed at a number ratio of 1:1:1 to prepare a 1.5 μM each solution in HEPES buffer. The mixed solution was left to stand for 3 hours at room temperature, thereby obtaining a complex sample solution.

(4) Immobilization of the Complex

The CMD glass substrate prepared above was set in a surface prep unit of a surface plasmon resonance analyzer (trade name: BIACORE3000, manufactured by Biacore). Using the surface prep unit, 70 μl of a mixed aqueous solution of 0.2 mM EDC and 0.04 mM NHS was added to the glass substrate at a flow rate of 10 μl/min. Subsequently, 30 μl of a two-fold dilution of the above complex sample solution with an acetate buffer (pH 4.5) was injected onto the glass substrate, and then blocking treatment was performed with an ethanolamine solution to immobilize the complex.

(5) Washing of the Antigen

After the immobilization of the complex, the substrate was subjected to 1-minute washing for five times by alternately using a glycine buffer (pH 1.5) and 10 mM NaOH to remove the antigen, thereby obtaining an immobilization substrate A of Example 1. The fluorescence intensity of the substrate after washing was measured using FLA-8000 (trade name, manufactured by FUJIFILM Corporation) and the intensity ratio between the emission at approximately 570 nm and the emission at approximately 675 nm was determined.

(6) Evaluation of the Change in the Amount of the Fluorescence by the Antigen

1 μM of lysozyme was injected onto the immobilization substrate A obtained above over 1 minute, and then the substrate was washed with the HEPES buffer solution. Subsequently, the fluorescence intensity was measured by using FLA-8000 and the intensity ratio between the emission at approximately 570 nm and the emission at approximately 675 nm was determined. The intensity ratio between the emission at approximately 570 nm and the emission at approximately 675 nm obtained in this manner was divided by the intensity ratio between the emission at approximately 570 nm and the emission at approximately 675 nm obtained in section (5) above, thereby determining the change in the emission intensity ratio before and after the addition of lysozyme.

Example 2

The immobilization substrate A used in Example 1 was subjected to 1-minute washing for five times by alternately using a glycine buffer (pH 1.5) and 10 mM NaOH to remove the antigen, thereby obtaining an immobilization substrate B of Example 2.

The fluorescence intensity of the immobilization substrate B was measured using FLA-8000 (trade name, manufactured by FUJIFILM Corporation) and the intensity ratio between the emission at approximately 570 nm and the emission at approximately 675 nm was determined.

Subsequently, 1 μM of lysozyme was injected onto the immobilization substrate B over 1 minute, and then the substrate was washed with the HEPES buffer solution. The fluorescence intensity was then measured by using FLA-8000 and the intensity ratio between the emission at approximately 570 nm and the emission at approximately 675 nm was determined.

### Example 3

An immobilization substrate C was prepared in the same manner as in Example 1, except that the mixing ratio among MBP-VH(HEL)-His10 labeled with ALEXA FLUOR 555, VL(HEL)-His10 labeled with ALEXA FLUOR 647 and lysozyme in formation of the complex was changed to 10:10:1. The intensity ratio between the emission at approximately 570 nm and the emission at approximately 675 nm of the immobilization substrate C before and after the addition of lysozyme was determined in the same manner as in Example 1.

### Comparative Example 1

An immobilization substrate D was prepared in the same manner as in Example 1, except that, in formation of the complex, MBP-VH(HEL)-His10 labeled with ALEXA FLUOR 555 and VL(HEL)-His10 labeled with ALEXA FLUOR 647 were added to the substrate for an identical amount of time, in an alternating mariner. The intensity ratio between the emission at approximately 570 nm and the emission at approximately 675 nm of the immobilization substrate D before and after the addition of lysozyme was determined in the same manner as in Example 1.

Determination of the Change in the Amount of the Fluorescence Before and After the Addition of Lysozyme

Based on the results obtained in Examples 1 to 3 and Comparative Example 1, the percentage of the change of the emission intensity ratio before and after the addition of lysozyme was determined based on the intensity ratio between the emission at approximately 570 nm and the emission at approximately 675 nm. The results are shown in Table 7.

TABLE 7

| | Immobilization | Percentage of the change of |
|---|---|---|
| | substrate | the emission intensity ratio |
| Example 1 | A | 5% |
| Example 2 | B | 5% |
| Example 3 | C | 6% |
| Comparative Example 1 | D | 0% |

As is apparent from Table 7, in the immobilization substrate (Comparative Example 1), which was prepared without forming the complex between the antibody fragments and the antigen and in which the positions of the antibody fragments on the substrate are not controlled, the change of the emission intensity ratio was not observed. On the other hand, each of the immobilization substrates of Examples 1, 2 and 3 exhibits increase in the percentage of the change of the emission intensity, which indicates that the antibody fragments are located adjacent to each other such that fluorescence resonance energy transfer occurs between them. Therefore, according to the present invention, the reaction of a complex composed of three or more substances can be detected, and the detection sensitivity and accuracy can be improved.

In addition, the immobilization substrate of Example 3, in which the mixing ration among anti-lysozyme VH-region polypeptide, anti-lysozyme VL-region polypeptide and lysozyme is 10:10:1, exhibits the approximately the same percentage of the change of the emission intensity ratio as that of Example 1, which shows that the complex can be efficiently formed even when the mixing ratio thereof is not equal.

In Examples and Comparative Example, a difference in the percentages of the change of the emission intensity ratio before and after the addition of the same concentration of lysozyme is approximately 5%. However, in Comparative Example (immobilization substrate D), the change was not detected even when a 1000-fold concentration (1 mM) of lysozyme was used (data not shown). These results indicate that, although the test sample cannot be detected by using the immobilization substrate of Comparative Example, the immobilization substrates according to the present invention indicates the application of fluorescence resonance energy transfer to the solid-phase to detect samples.

### Example 4

(1) Preparation of MBP-VL(HEL)-His10 Labeled with HILYTE FLUOR 555

100 μl of a solution containing the MBP-VL(HEL)-His10 obtained above (in HBS-N, about 796 μg/ml) was labeled with HILYTE FLUOR (registered trademark) 555 (manufactured by Dojindo Laboratories). The labeling reaction was performed at pH 7.0.

(2) Preparation of MBP-VH(HEL)-His10 Labeled with ALEXA FLUOR 647

300 μl of a solution containing the MBP-VH(HEL)-His10 obtained above (in HBS-N, about 150 μg/ml) was labeled with ALEXA FLUOR (registered trademark) 647 (manufactured by Molecular Probes). The labeling was performed at pH 7.0.

An immobilization substrate E of Example 4 was prepared in the same manner as in Example 1, except that the mixing ratio among MBP-VL(HEL)-His10 labeled with HILYTE FLUOR 555, MBP-VH(HEL)-His10 labeled with ALEXA FLUOR 647 and lysozyme in formation of the complex was changed to 10:10:2. The intensity ratio between the emission at approximately 570 nm and the emission at approximately 675 nm of the immobilization substrate E before and after the addition of 1 μM of lysozyme for 10 minutes was determined in the same manner as in Example 1.

### Example 5

The immobilization substrate E used in Example 4 was subjected to 1-minute washing for five times by alternately using a glycine buffer (pH 1.5) and 10 mM NaOH to remove the antigen, thereby obtaining an immobilization substrate F of Example 5.

The fluorescence intensity of the immobilization substrate F was measured using FLA-8000 (trade name, manufactured by FUJIFILM Corporation) and the intensity ratio between the emission at approximately 570 nm and the emission at approximately 675 nm was determined.

Subsequently, 1 μM of lysozyme was injected onto the immobilization substrate F over 10 minutes, and then the substrate was washed with the HEPES buffer solution. The fluorescence intensity was then measured by using FLA-8000 and the intensity ratio between the emission at approximately 570 nm and the emission at approximately 675 nm was determined.

### Example 6

The immobilization substrate F used in Example 5 was subjected to 1-minute washing for five times by alternately using a glycine buffer (pH 1.5) and 10 mM NaOH to remove the antigen, thereby obtaining an immobilization substrate G of Example 6.

The fluorescence intensity of the immobilization substrate G was measured using FLA-8000 (trade name, manufactured by FUJIFILM Corporation) and the intensity ratio between the emission at approximately 570 nm and the emission at approximately 675 nm was determined.

Subsequently, 100 nM of lysozyme was injected onto the immobilization substrate G over 10 minutes, and then the substrate was washed with the HEPES buffer solution. The fluorescence intensity was then measured by using FLA-8000 and the intensity ratio between the emission at approximately 570 nm and the emission at approximately 675 nm was determined.

### Comparative Example 2

An immobilization substrate H was prepared in the same manner as in Example 4, except that, in the immobilization of the complex, MBP-VL(HEL)-His10 labeled with HILYTE FLUOR 555 and MBP-VH(HEL)-His10 labeled with ALEXA FLUOR 647 were added to the substrate for an identical amount of time, in an alternating manner. The intensity ratio between the emission at approximately 570 nm and the emission at approximately 675 nm of the immobilization substrate H before and after the addition of lysozyme was determined in the same manner as in Example 4.

Determination of the Change in the Amount of the Fluorescence Before and After the Addition of Lysozyme

Based on the results obtained in Examples 4 to 6 and Comparative Example 2, the percentage of the change of the emission intensity ratio before and after the addition of lysozyme was determined based on the intensity ratio between the emission at approximately 570 nm and the emission at approximately 675 nm. The results are shown in Table 8.

TABLE 8

| | Immobilization | The percentage of the change |
|---|---|---|
| | substrate | of the emission intensity ratio |
| Example 4 | E | 10% |
| Example 5 | F | 11% |
| Example 6 | G | 5% |
| Comparative Example 2 | H | 0% |

As is apparent from Table 8, even when MBP-VL was labeled with the donor HILYTE FLUOR 555 and MBP-VH was labeled with the acceptor ALEXA FLUOR 647, the antibody-fragment immobilization substrate according to the present invention can be obtained. Therefore, it is thought that a similar measurement can be performed when MBP-VH and MBP-VL are labeled with donor and acceptor dyes respectively, or when MBP-VH and MBP-VL are labeled with acceptor and donor dyes respectively.

In addition, the results of Examples 5 and 6 indicate that the antibody-fragment immobilization substrate of the present invention can be used for repeated detection of the antigen even after washing. Further, since the emission intensity depends on an antigen concentration, the concentration of the antigen can be quantified using the antibody-fragment immobilization substrate of the present invention.

Furthermore, in the antibody-fragment immobilization substrate of the present invention, a similar measurement can be performed when either one of VH(HEL)-His10 and VL(HEL)-His10 is formed as the MBP fusion product, or when both of them are formed as the MBP fusion products, which indicates that the measurement can be performed regardless of whether or not the antibody fragment is an MBP fusion product.

### Example 7

(1) Preparation of a Fusion Protein of Anti-Osteocalcin (BGP) VH-Region Polypeptide (VH(BGP)) with MBP (MBP-VH(BGP)), and a Fusion Protein of Anti-BGP VL-Region Polypeptide with MBP (MBP-VL(BGP))

Abbreviations used in the Examples below are as follow:
LB: Same as that used in Example 1
LBA: Same as that used in Example 1
LBAG: Same as that used in Example 1
LBA plate: Same as that used in Example 1
SOC: Same as that used in Example 1
PBS: 10 mM phosphate buffer (pH 7.2) containing 137 mM NaCl and 2.7 mM KCl
5% IBPBS: PBS containing 5% (v/v) IMMUNOBLOCK (trade name, manufactured by Dainippon Sumitomo Pharma Co., Ltd., Osaka)
20% IBPBS: PBS containing 20% (v/v) IMMUNOBLOCK
PBST: PBS containing 0.1% of Triton-X 100
TAE buffer: Same as that used in Example 1
TALON buffer: Same as that used in Example 1
TALON elution buffer: Same as that used in Example 1
IPTG: Same as that used in Example 1
HBS-N buffer: Same as that used in Example 1

Similarly to Examples 1 to 6, water purified with MILLI-Q (trade name, manufactured by Millipore Co., Billerica, Mass.) was used in all experiments. Hereinafter the purified water is referred to as milliQ water. Unless otherwise specified, general reagents used were obtained from Sigma-Aldrich Co. (St. Louis, Mo., USA), Nacalai Tesque (Kyoto, Japan), Wako Pure Chemical Industries, Ltd. (Osaka, Japan), or Kanto Chemical Co. Inc. (Tokyo, Japan). Oligo DNAs were synthesized by Texas Genomics Japan (Tokyo, Japan) or Invitrogen (Tokyo, Japan).

The genotypes of the E. coli XL10-Gold, OverExpress C41, and HB2151 are shown in Table 9.

TABLE 9
XL-10 gold: Tetr Δ(mcrA) 183, Δ(mcrCB-hsdSMR-mrr) 173, endA1,
supE44, thi-1, recA1,
gyrA96, relA1, lac, Hte[F′ proAB, lacIq, ZΔM15, Tn10(Tetr), Tn5(Kanr),
Amy]
OverExpress C41(DE3): F−, ompT, hsdSB(rB− mB−), gal(λcI 857, ind1,
Sam7, nin5, lacUV5-T7gene1), dcm(DE3)
HB2151: K12d(lac-pro), thi/F′; pro A+B+, Lac IqZ dM15)

(A) Construction of Expression Plasmid for MBP-VH(BGP)

(a) Vectors Used in the Experiments
pET-MBPp-His6: pET15b vector (provided by Merck Chemicals Ltd., Darmstadt, Germany), into which the gene encoding maltose binding protein (MBP) tagged with His-Tag containing six histidine residues (His6) is inserted (described above, SEQ ID NO: 7).
pIT2-VH(BGP): pIT2 vector, into which the gene encoding a VH-region polypeptide of anti-BGP antibody (VH(BGP)) (SEQ ID NO: 14, Table 10, amino acid: SEQ ID NO: 15) is inserted.
pMAL-VL(BGP): an expression vector for a fusion protein of a VL-region polypeptide of anti-BGP antibody KTM219 and MBP (MBP-VL(BGP)) (described in, Lim et al. Anal. Chem. 79, 6193(2007)).

TABLE 10
VH(BGP)

GAGGTACAGCTGGAGGAGTCTGGGGCTGAGTTTGTGAAGGCTGGGGCTTC
AGTGAAGCTGTCCTGCAAGACTTCTGGCTACACCTTCAACAACTACTGGA
TTCACTGGGTCAAACAGAGCCCAGGACAAGGCCTTGAATGGATCGGAGAA
ATTGATCCCTCTGATGGTTATTCTAACTACAATCAAAAATTCAAGGGCAA
GGCCACATTGACTGTGGACAAGTCCTCCAGCACTGCCTACATGCACCTCA
ACAGTCTGACTTCTGAGGACTCTGCGGTCTATTATTGTACAAGCAGCACT
TCGGTAGGAGGTTCCTGGGGCCAAGGGACCACGGTCACCGTCTCGAGC

(b) Restriction Enzyme Treatment of pET-MBPp-His6

To 77 μl of an aqueous solution containing about 10 μg of pET-MBPp-His6, 3 μl of NotI (Roche Applied Science, Base1, Switzerland, 10 U), 10 μl of 10× BSA solution and 10 μl 10×H buffer (Roche Applied Science) were add, and the mixture was then left to stand for about 3 hours at 37° C. Subsequently, DNA was purified using WIZARD SV Gel And PCR Clean-Up System (trade name, manufactured by Promega Co., Madison, Wis.) and dissolved in 50 μl of milliQ water. To the solution, 3 μl of SfiI (Roche Applied Science, 10 U), 7 μl of 10×BSA solution and 7 μl of 10×M buffer (Roche Applied Science) were added, and the mixture was then left to stand for about 3 hours at 50° C. Subsequently, the mixture was subjected to electrophoresis on 1% agarose gel (in TAE buffer), and then a DNA band of approximately 4,100 by was excised and extracted using WIZARD SV Gel And PCR Clean-Up System (Promega Co.). The extracted DNA was dissolved in 50 μl of milliQ water.

(c) Isolation of VH(BGP) Gene Fragment from the pIT2-VH(BGP)

To 77 μl of an aqueous solution containing about 10 μg of pIT2-VH(BGP), 3 μl of NotI (Roche Applied Science, 10 U), 10 μl of 10× BSA solution and 10 μl 10×H buffer (Roche Applied Science) were added, and the mixture was then left to stand for about 3 hours at 37° C. Subsequently, DNA was purified using WIZARD SV Gel And PCR Clean-Up System (Promega Co.) and the purified DNA was dissolved in 50 μl of milliQ water. To the DNA solution, 3 μl of SfiI (Roche Applied Science, 10 U), 7 μl of 10×BSA solution, and 7 μl of 10×M buffer (Roche Applied Science) were added and the mixture was then left to stand for about 3 hours at 50° C. Subsequently, the mixture was subjected to electrophoresis on 1% agarose gel (in TAE buffer), and then a DNA band of approximately 450 bp was excised and extracted using WIZARD SV Gel And PCR Clean-Up System (Promega Co.). The extracted DNA was dissolved in 50 μl of milliQ water.

(d) Incorporation of VH(BGP) Into the pET-MBPp-His6

0.5 μl of a solution containing pET-MBPp-His6, which was treated with the restriction enzymes and purified as described above, and 5 μl of a solution of VH(BGP), which was treated with the restriction enzymes and purified as described above, were mixed. Subsequently, 5.5 μl of DNA LIGATION HIGH Vert Solution (TOYOBO Co., Ltd., Osaka) was added to the mixture, and then DNA ligation was performed for 30 minutes at 16° C. Thereafter, about 50 μl of E. coli XL10-Gold chemical competent cells were transformed with about 1 μl of the ligation reaction mixture. The transformants were cultured on a LBAG agar medium overnight at 37° C. A single-colony transformant was further cultured in 50 ml of LBAG overnight. The plasmid DNA was then extracted using WIZARD PLUS MINIPREPS DNA Purification Kit (Promega Co.), thereby obtaining pET-MBPp-VH(BGP). The DNA sequence of pET-MBPp-VH(BGP) was confirmed in accordance with a protocol from Beckman Coulter, Inc.

(B) Preparation of MBP-VH(BGP) Protein and MBP-VL(BGP) Protein

The pET-MBPp-VH(BGP) plasmid and the pMAL-VL(BGP) plasmid were respectively transformed into E. coli OverExpress C41(DE3) by heat shock method for the expression. 1 μl of the plasmid (about 100 ng) and 100 μl of OverExpress C41(DE3) competent cells were mixed, and the mixture was then left to stand for 30 min on ice. Subsequently, heat shock was performed for 45 seconds at 42° C. Immediately after the heat shock, the resultant was left to stand for 2 minutes on ice. Thereafter, the cells were cured for 30 minutes by adding 200 μl of SOC medium thereto. The mixture was then spread on an LBA plate and incubated overnight at 37° C.

A grown colony was inoculated into 4 ml of LBAG and cultured overnight at 30° C. with shaking. 4 ml of the small-scale culture was then added to 800 ml of LBA, and cultured at large scale at 30° C. with shaking. When an O.D.600 of the culture reached between 0.5 and 0.6, 400 μl of 1000 mM IPTG was added thereto and further cultured overnight at 20° C. with shaking. The bacterial culture was then separated into supernatants and pellets of E. coli by centrifugation. By the methods described below, each of the MBP-VH(BGP) protein (SEQ ID NO: 16, Table 11) was independently collected from the supernatants by ammonium sulfate precipitation method and from the pellet by ultrasonication of bacterial cells. Further, the MBP-VL(BGP) protein (SEQ ID NO: 17, Table 12) was independently collected from the supernatants by ammonium sulfate precipitation method and from the pellet by ultrasonication of bacterial cells.

TABLE 11
MBP-VH(BGP)

MKIKTGARILALSALTTMMFSASALAKIEEGKLVIWINGDKGYNGLAEVG
KKFEKDTGIKVTVEHPDKLEEKFPQVAATGDGPDIIFWAHDRFGGYAQSG
LLAEITPDKAFQDKLYPFTWDAVRYNGKLIAYPIAVEALSLIYNKDLLPN
PPKTWEEIPALDKELKAKGKSALMFNLQEPYFTWPLIAADGGYAFKYENG
KYDIKDVGVDNAGAKAGLTFLVDLIKNKHMNADTDYSIAEAAFNKGETAM
TINGPWAWSNIDTSKVNYGVTVLPTFKGQPSKPFVGVLSAGINAASPNKE
LAKEFLENYLLTDEGLEAVNKDKPLGAVALKSYEEELAKDPRIAATMENA
QKGEIMPNIPQMSAFWYAVRTAVINAASGRQTVDEALKDAQTNSSSNNNN
NNNNNNLGPGAAHYVEFAAQPAEVQLEESGAEFVKAGASVKLSCKTSGYT
FNSYWIHWIKQSPGQGLEWIGEIDPSDGYTNYNQKFKGKATLTVDKSSST
AYMRLNSLTSEDSAVYYCTSSTSVGGSWGQGTTVTVSSHHHHHH

TABLE 12
MBP-VL(BGP)

MKIKTGARILALSALTTMMFSASALAKIEEGKLVIWINGDKGYNGLAEVG
KKFEKDTGIKVTVEHPDKLEEKFPQVAATGDGPDIIFWAHDRFGGYAQSG
LLAEITPDKAFQDKLYPFTWDAVRYNGKLIAYPIAVEALSLIYNKDLLPN
PPKTWEEIPALDKELKAKGKSALMFNLQEPYFTWPLIAADGGYAFKYENG
KYDIKDVGVDNAGAKAGLTFLVDLIKNKHMNADTDYSIAEAAFNKGETAM
TINGPWAWSNIDTSKVNYGVTVLPTFKGQPSKPFVGVLSAGINAASPNKE
LAKEFLENYLLTDEGLEAVNKDKPLGAVALKSYEEELAKDPRIAATMENA
QKGEIMPNIPQMSAFWYAVRTAVINAASGRQTVDEALKDAQTNSSSNNNN
NNNNNNLGIEGRISEFASTDIELTQSPLSLPVSLGDQASISCTSSQSLLH
SNGDTYLHWYLQKPGQSPKLLIYTLSNRFSGVPDRFSGSGSGTDFTLKIS
RVEAADLGIYFCSQTTHVPYTFGGGTKLEIKRHHHHHHGAAEQKLISEED
LNGAA

In the case of using the supernatant, 344 g of ammonium sulfate was added to about 800 ml of the culture supernatant, and the mixture was stirred overnight at 4° C. Subsequently, an insoluble matter containing MBP-VH(BGP) or MBP-VL(BGP) was collected by centrifugation, and the pellet was suspended in 30 ml of TALON buffer. In the case of using the pellet of E. coli, the pellet was suspended in 30 ml of TALON buffer and then subjected to ultrasonication, followed by centrifugation, to collect a supernatant containing MBP-VH(BGP) or MBP-VL(BGP). The supernatant was dialyzed against the TALON buffer. Each protein collected in TALON buffer was applied to a column (16 mm-diameter×about 15 mm-height) filled with a TALON affinity resin (Clontech Laboratories, Inc., Mountain View, Calif.). Subsequently, TALON affinity resin, onto which the protein was adsorbed, was washed with the TALON buffer, and then a TALON elution buffer was added to elute MBP-VH(BGP) or MBP-VL(BGP). The purified protein was confirmed by SDS-PAGE. The buffer of the eluate was changed to HBS-N, and then glycerol was added thereto at a final concentration of 16%. The obtained solution was stored at −80° C.

(C) Preparation of MBP-VH(BGP) Labeled with ALEXA FLUOR 555

100 μl of a solution containing the MBP-VH(BGP) obtained above (in HBS-N, about 1.2 mg/ml) was labeled with ALEXA FLUOR (registered trademark) 555 (manufactured by Molecular Probes). The labeling reaction was performed at pH 7.0.

(D) Preparation of MBP-VL(BGP) Labeled with ALEXA FLUOR 647

430 μl of a solution containing the MBP-VL(BGP) obtained above (in HBS-N, about 150 μg/ml) was labeled with ALEXA FLUOR (registered trademark) 647 (manufactured by Molecular Probes). The labeling was performed at pH 7.0.

(2) Fabrication of a Substrate Provided with a Carboxyl Group

(A) Washing the Substrate

A glass slide (manufactured by Matsunami Glass Ind., Ltd) was irradiated with UV, and immersed in acetone and ultrasonicated for 5 minutes. Subsequently, the glass slide was removed from acetone and washed with purified water.

(B) Providing an Amino (APS) Group

72 ml of ethanol and 8 ml of purified water were mixed in a 100 ml glass vial. The mixed solution was heated for about 15 minutes at 60° C. in an incubator (manufactured by AS ONE Corporation). To the heated mixed solution of ethanol and purified water, 80 μl of APS (γ-aminopropyltriethoxysilane) (manufactured by Tokyo Chemical Industry Co., Ltd.) (0.1% v/v) was added and dissolved. Subsequently, the washed glass slide was immersed in this solution and allowed to react in the incubator (manufactured by AS ONE Corporation) for 15 minutes at 60° C., thereby obtaining a glass slide provided with the amino group. After the reaction, the glass slide was removed from the solution, and then washed by immersing the glass slide into a solution of ethanol and water at a ratio of 9:1 and then removing it. The washing was repeated three times. The glass slide after the washing was dried by blowing nitrogen gas thereon and baked for 1 hour at 120° C. After the baking, the glass slide was washed by sequentially immersing it in ethanol and purified water.

(C) Active Esterification of CMD

To a 0.5% by mass solution of CMD (carboxymethyl dextran, manufactured by Meito Sangyo Co., Ltd., molecular weight 1,000,000) dissolved in ultrapure water, a mixed solution containing 0.4 M EDC (1-(3-Dimethylaminopropyl)-3-ethylcarbodiimide) and 0.1 M NHS (N-Hydroxysuccinimide) was added, being an amount calculated such that 2% of the carboxyl group in CMD is activated when the entire amount was reacted, and stirred for 5 minutes at room temperature.

(D) Preparation of a CMD Film

The active esterified CMD solution was dropped onto the above prepared glass substrate having the amino group thereon. After 30 seconds, the solution was removed, whereby a thin film of active esterified carboxy methyl dextran was formed on the substrate having the amino group. The substrate was reacted for 1 hour at room temperature, and then washed once with 0.1 N NaOH and once with ultrapure water.

(3) Formation of a Complex

MBP-VH(BGP) labeled with ALEXA FLUOR 555 and MBP-VL(BGP) labeled with ALEXA FLUOR 647, both of which were prepared above, and the C-terminal heptapeptide fragment of BGP (RRFYGPY: SEQ ID NO: 18) were mixed at a number ratio of 4:1:4 to form a solution containing 2 μM of MBP-VH(BGP) labeled with ALEXA FLUOR 555 in HEPES buffer. The mixed solution was left to stand for 3 hours at room temperature, thereby obtaining a complex sample solution.

(4) Immobilization of the Complex

The CMD glass substrate prepared above was set in a surface prep unit of a surface plasmon resonance analyzer (trade name: BIACORE3000, manufactured by Biacore). Using the surface prep unit, 70 μl of a mixed aqueous solution of 0.2 mM EDC and 0.04 mM NHS was added to the glass substrate at a flow rate of 10 μl/min. Subsequently, 70 μl of a two-fold dilution of the above complex sample solution with an acetate buffer (pH 4.5) was injected onto the glass substrate, and then blocking treatment was performed with an ethanolamine solution to immobilize the complex.

(5) Washing of the Antigen

After the immobilization of the complex, the substrate was subjected to 1-minute washing for five times by alternately using a glycine buffer (pH 1.5) and 10 mM NaOH to remove the antigen, thereby obtaining an immobilization substrate I of Example 7. The fluorescence intensity of the substrate after washing was measured using FLA-8000 (trade name, manufactured by FUJIFILM Corporation) and the intensity ratio between the emission at approximately 570 nm and the emission at approximately 675 nm was determined.

(6) Evaluation of the Change in the Amount of the Fluorescence by the Antigen

100 nM of the BGP heptapeptide (RRFYGPY) was injected onto the immobilization substrate I obtained above over 10 minutes, and then the substrate was washed with the HEPES buffer solution. Subsequently, the fluorescence intensity was measured by using FLA-8000 and the intensity ratio between the emission at approximately 570 nm and the emission at approximately 675 nm was determined. The intensity ratio between the emission at approximately 570 nm and the emission at approximately 675 nm obtained in this manner was divided by the intensity ratio between the emission at approximately 570 nm and the emission at approximately 675 nm obtained in section (5) above, thereby determining the change in the emission intensity ratio before and after the addition of the BGP heptapeptide (RRFYGPY).

### Example 8

The immobilization substrate I used in Example 7 was subjected to 1-minute washing for five times by alternately using a glycine buffer (pH 1.5) and 10 mM NaOH to remove the antigen, thereby obtaining an immobilization substrate J of Example 8.

The fluorescence intensity of the immobilization substrate B was measured using FLA-8000 (trade name, manufactured by FUJIFILM Corporation) and the intensity ratio between the emission at approximately 570 nm and the emission at approximately 675 nm was determined.

Subsequently, 1 μM of BGP heptapeptide (RRFYGPY) was injected onto the immobilization substrate J over 10 minutes, and then the substrate was washed with the HEPES buffer solution. The fluorescence intensity was then measured by using FLA-8000 and the intensity ratio between the emission at approximately 570 nm and the emission at approximately 675 nm before and after the addition of the BGP heptapeptide (RRFYGPY) was determined

### Comparative Example 3

An immobilization substrate K was prepared in the same manner as in Example 7, except that, in the immobilization of the complex, MBP-VH(BGP) labeled with ALEXA FLUOR 555 and MBP-VL(BGP) labeled with ALEXA FLUOR 647 were added to the substrate for an identical amount of time, in an alternating manner. The intensity ratio between the emission at approximately 570 nm and the emission at approximately 675 nm of the immobilization substrate K before and after the addition of the BGP heptapeptide (RRFYGPY) was determined in the same manner as in Example 7.

Determination of the Change in the Amount of the Fluorescence Before and After the Addition of the BGP Heptapeptide (RRFYGPY)

Based on the results obtained in Examples 7 and 8 and Comparative Example 3, the percentage of the change of the emission intensity ratio before and after the addition of the BGP heptapeptide (RRFYGPY) was determined based on the intensity ratio between the emission at approximately 570 nm and the emission at approximately 675 nm. The results are shown in Table 13.

TABLE 13

| | Immobilization | The percentage of the change |
|---|---|---|
| | substrate | of the emission intensity ratio |
| Example 7 | I | 3% |
| Example 8 | J | 8% |
| Comparative Example 3 | K | 0% |

As is apparent from Table 13, a low-molecular-weight antigen can be detected by using the antibody-fragment immobilization substrate according to the present invention, which indicates a higher versatility of antigens. Since the change of the emission intensity in antibody-fragment immobilization substrates of Examples 7 and 8 depends on the concentration of the antigen even when a low-molecular-weight antigen is used, the concentration of the antigen can be quantified using the antibody-fragment immobilization substrate of the present invention. In the immobilization substrate K (Comparative Example 3), as is the case with lysozyme, the change was not detected even when a 10000-fold concentration (1 mM) of BGP heptapeptide (RRFYGPY) was used (data not shown).

Accordingly, the present invention provides an immobilization substrate that can precisely and simply detect a targeted molecule in a short time and that can be repeatedly used after washing. In addition, since the linker design is not required, the present invention also provides a method that can efficiently produce an immobilization substrate having greater versatility.

All publications, patent applications, and technical standards mentioned in this specification are herein incorporated by reference to the same extent as if each individual publication, patent application, or technical standard was specifically and individually indicated to be incorporated by reference.

1. An antibody-fragment-immobilizing substrate comprising a substrate and at least one set of antibody fragments,
wherein antibody fragments of each set include at least two types of separate antibody fragments,
the at least two types of separate antibody fragments include at least one type of labeled antibody fragment having a labeled site labeled with a luminescent substance and at least one type of acceptor antibody fragment having an acceptor site for accepting emission from the labeled antibody fragment, and
the at least one type of labeled antibody fragment and the at least one type of acceptor antibody fragment are capable of cooperatively recognizing one type of antigen and are independently immobilized on the substrate in a positional relationship that allows each of the antibody fragments in one set to bind to the same antigen.

2. The antibody-fragment-immobilizing substrate according to claim 1, wherein the at least two types of antibody fragments comprise a VH-region polypeptide and a VL-region polypeptide.

3. The antibody-fragment-immobilizing substrate according to claim 1, further comprising a polymer layer and wherein the at least two types of antibody fragments are immobilized on the polymer layer.

4. The antibody-fragment-immobilizing substrate according to claim 3, wherein the thickness of the polymer layer is from 1 nm to 0.5 mm.

5. The antibody-fragment-immobilizing substrate according to claim 3, wherein the polymer layer is bound to the substrate through a self-assembled monolayer.

6. The antibody-fragment-immobilizing substrate according claim 5, wherein the thickness of the self-assembled monolayer is from 0.2 nm to 10 μm.

7. The antibody-fragment-immobilizing substrate according to claim 3, wherein the polymer is a polysaccharide.

8. The antibody-fragment-immobilizing substrate according to claim 1, wherein the luminescent substance is at least one selected from a fluorescent dye or a fluorescent protein.

9. The antibody-fragment-immobilizing substrate according to claim 1, wherein a fluorescence resonance energy transfer occurs between the labeled antibody fragment and the acceptor antibody fragment.

10. The antibody-fragment-immobilizing substrate according to claim 1, which is used for a bioreactor or biosensor based on a binding reaction between the at least two types of antibody fragments and the antigen.

11. A method for producing an antibody-fragment-immobilizing substrate comprising:
contacting separate antibody fragments of at least two types that include at least one type of labeled antibody fragment having a labeled site labeled with a luminescent substance and at least one type of acceptor antibody fragment having an acceptor site for accepting emission from the labeled antibody fragment and that are capable of cooperatively recognizing one type of antigen, with the antigen, and forming a complex whereby each of the antibody fragments binds to the antigen;
immobilizing the complex on a substrate via the antibody fragments in the complex; and
removing the antigen from the complex to obtain the antibody-fragment-immobilizing substrate, wherein the antibody fragments are independently immobilized on the substrate in a positional relationship that allows each of the antibody fragments to bind to the same antigen.

12. The method for producing the antibody-fragment-immobilizing substrate according to claim 11, wherein the antibody fragments comprise a VH-region polypeptide and a VL-region polypeptide.

13. The method for producing the antibody-fragment-immobilizing substrate according to claim 11, wherein the contacting include mixing the antibody fragments and the antigen such that the ratio of the number of antigens to the valencies of molecules formed by a combination of antibody fragments is from 0.1:1 to 10:1.

14. The method for producing the antibody-fragment-immobilizing substrate according to claim 11, wherein the removing is performed such that the avidity of the antibody fragments and the antigen in the complex is reduced.
